(19) United States
(12) Patent Application Publication
(10) Pub. No.: US 2019/0141916 A1
(43) Pub. Date: May 16, 2019

(54) PORTABLE UNDERGROUND IRRIGATION DEVICE

(71) Applicants: Chantal B. Auguste, West Palm Beach, FL (US); Marc B. Auguste, Thetford-Mines (CA); Brenda Pomerance, New York, NY (US)

(72) Inventors: Chantal B. Auguste, West Palm Beach, FL (US); Marc B. Auguste, Thetford-Mines (CA); Brenda Pomerance, New York, NY (US)

(73) Assignee: Chantal B. Auguste, West Palm Beach, FL (US)

(21) Appl. No.: 15/810,224

(22) Filed: Nov. 13, 2017

(51) Int. Cl. A01G 25/06

(52) U.S. Cl. CPC A01G 25/06; A01G 9/122

(57) ABSTRACT

A portable device for irrigating the roots of plants has a handle, a stem, and a removable base supporting removable spikes. The stem of the device is adapted for connection to a hose. The spikes each have openings for delivering water. The device has an on/off switch, which may be manually operated or electronically operated. The device is configured to optionally allow the flow of another substance into the stem of the rake, such as plant food.

### BACKGROUND OF THE INVENTION

The present invention relates soil irrigation systems, and more particularly, is directed to a portable rake-shaped device having prongs for insertion into and irrigation of soil.

Above-ground sprinklers are easy to place, but fail to deliver a considerable amount of the water where it is most needed: the roots of plants.

Underground irrigation systems are difficult to move, so they are inappropriate for gardens whose layout changes from year to year, such as vegetable gardens.

U.S. Pat. No. 9,232,780 (Cink) shows a handheld device for applying pesticides below the ground surface. Cink's device has a handle, compressible vertical shaft (like a pogo stick) and manifold head with multiple nozzles. Compression of the vertical shaft activates an electronic switch to urge soil treatment fluid through the nozzles via high pressure, to inject the soil treatment to a predetermined depth. The pesticide can be on a cart or in a backpack, and mixed with water.

PCT Patent No. WO 2010/114509 (Skarphol) shows an irrigation spike having an outer shell with a point, and perforations to deliver fluid from an inner chamber. The spike includes a flow controller. The end of the spike is removable. In an irrigation system, a plurality of spikes are driven into the ground and connected to a fluid source.

U.S. Pat. No. 5,671,887 (Iavarone) shows a high pressure water sprayer with shaft 12 coupled to screw-in spray nozzle 14 having multiple openings for delivering fluid. Lid assembly 18 includes liquid retention jar 54 for liquid fertilizer. A handle has open and closed positions.

U.S. Pat. No. 9,161,499 (Bailey) teaches a wireless irrigation controller.

U.S. Pat. No. 7,225,585 (Zayeratabat) shows plant stake support and deep root feeder 10. The stake has a spike at its bottom, inserted into soil. The spike has holes so that moisture from the soil at the top of the spike is delivered to the bottom of the spike.

However, there is room for improvement in soil irrigation systems.

### SUMMARY OF THE INVENTION

In accordance with an aspect of this invention, there is provided a portable irrigation device comprising a handle for receiving the hand of a user; a stem having a substantially cylindrical shape with a hollow interior, an elongated side, a first end and a second end, the first end connected to the handle, the stem having an opening along its elongated side for connection to a fluid source; a base having a hollow interior, a top opening connected to the second end of the stem, and having at least one bottom opening; and at least one irrigation spike having a hollow interior, a top end connected to the bottom opening of the base, a bottom conical tip, and at least one opening in the irrigation spike near the conical tip.

According to another aspect of this invention, there is provided a kit for a portable irrigation device, comprising at least one handle having an end for mating with an end of a stem; at least one stem, the stem having a hollow interior a generally cylindrical shape, the stem having two ends, one stem having an opening in its side for connection to a fluid source; at least one base, the base having a hollow interior, a top opening for mating with an end of the at least one stem, and at least one bottom opening; and at least one irrigation spike, the irrigation spike having a hollow interior, a top end with an opening, the top end for mating with one of the at least one bottom opening of the base, a generally cylindrical-shaped side with at least one opening, and a bottom end in the shape of a cone; wherein assembly of the irrigation device comprises removably coupling (a) the end of the handle to one end of the stem, (b) the top opening of the base to the other end of the stem, and (c) the top end of the irrigation spike to the bottom opening of the base.

According to a further aspect of this invention, there is provided a kit for a portable irrigation system, comprising at least two irrigation rakes, a pipe for connecting to the opening in the stem of each of the irrigation rakes, and a spigot for connecting to the pipe; each irrigation rake having at least one handle having an end for mating with an end of a stem; at least one stem, the stem having a hollow interior a generally cylindrical shape, the stem having two ends, one stem having an opening in its side for connection to a fluid source; at least one base, the base having a hollow interior, a top opening for mating with an end of the at least one stem, and at least one bottom opening; and at least one irrigation spike, the irrigation spike having a hollow interior, a top end with an opening, the top end for mating with one of the at least one bottom opening of the base, a generally cylindrical-shaped side with at least one opening, and a bottom end in the shape of a cone.

It is not intended that the invention be summarized here in its entirety. Rather, further features, aspects and advantages of the invention are set forth in or are apparent from the following description and drawings.

### BRIEF DESCRIPTION OF THE DRAWINGS

FIGS. 1A-1D are diagrams of irrigation rakes;

FIGS. 2A and 2B are diagrams of handles for an irrigation rake;

FIGS. 3A-3C are diagrams of stem configurations for the an irrigation rake;

FIGS. 4A-4F are diagrams of bases for an irrigation rake;

FIGS. 5A-5D are diagrams of spikes for an irrigation rake;

FIG. 6 is a diagram of an elevated water supply for an irrigation rake;

FIG. 7 is a diagram of a faucet attachment used with an irrigation rake;

FIG. 8 is a diagram of a portable irrigation system;

FIGS. 9A-9F are diagrams of components of the portable irrigation system of FIG. 8;

FIG. 10 is a diagram of a portable irrigation and fencing system in the ground;

FIGS. 11A-11C are diagrams of components of the portable irrigation and fencing system of FIG. 10;

FIG. 12 is a diagram of a portable irrigation system and controller;

FIG. 13 is a flowchart for server set-up;

FIG. 14 is a flowchart for controller set-up;

FIG. 15 is a diagram of a user interface showing an irrigation configuration diagram;

FIG. 16 is a flowchart for server operation;

FIGS. 17-19 are diagrams of user interfaces; and

FIGS. 20A-20I are a flowchart for controller operation.

### DETAILED DESCRIPTION

The present invention is a portable device for irrigating the roots of plants. The device has a handle, a stem, and a removable base supporting removable irrigation spikes. Each of the stem, the base and the irrigation spikes has a hollow interior. The stem of the device has an opening in its side for connection to a hose. The spikes each have openings for delivering water. The device has an on/off switch, which may be manually operated or electronically operated. The device is configured to optionally allow the flow of another substance into the stem, such as plant food.

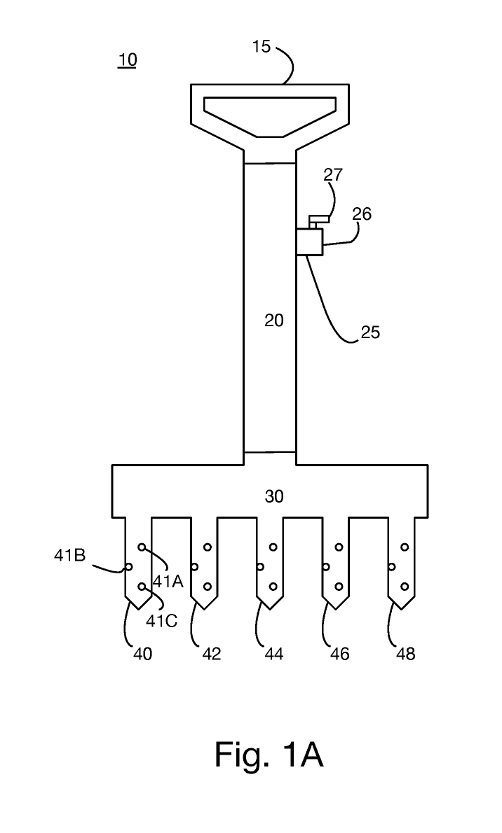

Referring now to the drawings, and in particular to FIG. 1A, there is illustrated irrigation rake 10 having handle 15, stem 20, spigot 25, on/off valve 27, removable base 30 and removable irrigation spikes 40, 42, 44, 46, 48. Removable irrigation spike 40 has openings 41A-41D disposed along its length; removable irrigation spikes 42, 44, 46, 48 have similar openings disposed along their length. The components are irrigation rake 10 are plastic, but other materials may be used such as but not limited to stainless steel, aluminum, powdered aluminum, other metal, ceramic, wood or bamboo. The components of irrigation rake 10 may be made from diverse materials, e.g., stainless steel handle 15, plastic stem 20, brass spigot 25, plastic base 30 and ceramic irrigation spikes 40-48.

Handle 15 enables a person's hand to conveniently hold irrigation rake. Handle 15 has a width of about 5 inches and a height of about 4 inches, although any size suitable for a human hand may be used.

Stem 20 is substantially a hollow cylinder with an opening for spigot 25. Stem 20 is adapted to receive fluid flow from spigot 25 and direct the fluid flow to base 30. Stem 20 has an outer diameter of about 2 inches and a length of about 36 inches. Different embodiments have different sizes, such as an outer diameter of about 0.75, 1.0 or 1.5 inches. In the embodiment shown, spigot 25 inserts into stem 20 at a right angle (90 degrees); in other embodiments, spigot 25 inserts into stem 20 at an acute angle (less than 90 degrees between stem 20 and spigot 25). Spigot 25 has opening 26 for connecting to a conventional garden hose.

Handle 15, spigot 25 and base 30 are connected to stem 20 via a threaded connection, with threads on the outsides of stem 20 and the insides of handle 15 and base 30. Handle 15 and base 30 are respectively screwed on to stem 20. Stem 20 has an opening in its elongated side, with threads on the inside, for mating with threads on the outside of spigot 25. Spigot 25 is screwed into stem 20. In other embodiments, instead of a threaded connection, the connection is press-fit; other suitable, usually reversible, connection techniques are used in other embodiments.

Spigot 25 is substantially a hollow cylinder configured to mate with a standard garden hose connector at opening 26. Spigot 25 has a diameter of about 0.75 inches. Spigot 25 is connected to and controlled by on/off valve 27.

On/off valve 27 is adapted to be manually operated to allow or prevent fluid flow through spigot 25 and thence to stem 20. In other embodiments, on/off valve 27 is electronically operated such as via a Bluetooth signal from a smartphone or other computing device.

Base 30 is substantially a hollow three-dimensional rectangular shape, having size of about 8 inches width, 4 inches height and 2 inches depth. In some embodiments, base 30 is substantially a hollow cylinder. The top of base 30 has a fitting with threads on the inside, for mating with the threaded bottom of stem 20. The bottom of base 30 has five openings, each with threads on their insides, for mating with threads on the outsides of spikes 40-48. Base 30 is adapted to distribute fluid flowing from stem 20 to spikes 40-48.

Irrigation spikes 40-48 are similar; for brevity, only irrigation spike 40 will be discussed.

Irrigation spike 40 is substantially a hollow cylinder, having size of about 4 inches in length and 0.5 inches in diameter.

The top end of irrigation spike 40 is threaded on its outside, so irrigation spike 40 can be screwed into an opening on the bottom of base 30. Removability of irrigation spike 40 is advantageous because (a) removability facilitates cleaning irrigation spike 40 if its openings 41A-41C become clogged with dirt or stones, (b) removability enables easy replacement of a broken spike, (c) removability enables different size spikes to be used for different environments, and (d) removability makes it easier to package, ship and store irrigation rake 10.

The elongated sides of irrigation spike 40 have openings 41A-41C positioned so that fluid flowing from base 30 is uniformly distributed in a radial direction from irrigation spike 40 to the soil in which irrigation spike 40 is inserted. None of openings 41A-41C are close to the top of irrigation spike 40, to ensure that water does not shoot onto the soil surface. In a variation, openings 41A-41D are along one side of irrigation spike 40 so that fluid flow from rake 10 can be directed to plant roots in soil adjacent to irrigation spike 40.

The bottom end of irrigation spike 40 is a solid conical tip, adapted for pushing through soil.

Openings 41A-41D are the same size, of about 0.125 inches diameter. In other embodiments, openings 41A-41D have respectively different sizes.

In other embodiments, instead of irrigation spikes 40-48 and the openings in base 30 being threaded for mating, they are configured to snap-in; other suitable, usually reversible, connection techniques are used in other embodiments.

To operate irrigation rake 10, the user assembles its parts as shown in FIG. 1: handle 15 is screwed onto the top end of stem 20, spigot 25 is screwed into the side of stem 20, and the top of base 30 is screwed onto the bottom end of stem 20. Valve 27 is set to its off position. Irrigation spikes 40-48 are screwed into the openings in the bottom of base 30. A garden hose (not shown) is connected to spigot 25, and a faucet (not shown) is turned on so that water flows through the garden hose to irrigation rake 10.

Then, the user carries irrigation rake 10 to a soil location, either in the ground or in a pot, pushes irrigation rake 10 into the soil so that spikes 40-48 are in the area to be irrigated, moves valve 27 to its on position, and waits for a suitable duration—such as but not limited to 5-10 seconds—so fluid can flow from the garden hose through irrigation rake 10 through spikes 40-48, irrigating the soil. The user then moves valve 27 to its off position, pulls irrigation rake 10 from the soil, and carries irrigation rake 10 to another location. When watering is complete, the user turns off the faucet (not shown) controlling water flow to the garden hose (not shown), and detaches the garden hose from irrigation rake 10.

Irrigation rake 10 enables fluid to be efficiently and quickly directed to plant roots, not wasted through evaporation if sprinkled on the top of the soil. Only desired plants can be watered, i.e., weeds need not be watered. Plants can be given different amounts of water, depending on their hydration needs: cacti need little water, whereas flowering plants are thirstier. Because irrigation rake 10 is easily portable, the user can readily change the plant configurations and plant types in her/his garden, in contrast to conventional irrigation systems that are difficult to adapt to different plant configurations and thus force the user to keep the same configuration, year after year.

The components of an irrigation rake can be sold in kit form. For instance, a starter kit includes a handle, stem, spigot, base and a first set of irrigation spikes, while an indoor/outdoor kit includes interchangeable handles, a stem, a spigot, extender stems of differing length, interchangeables bases, and set of different irrigation spikes. Other component combinations are provided in other kits. Additional and/or replacement components can be sold individually. A case (not shown) for storing components when not in use can be sold as an accessory and/or included with each kit.

FIGS. 1B and 1C show examples of irrigation rakes made from mix-and-match components.

FIG. 1B shows irrigation rake 10′ which is similar to irrigation rake 10, except as discussed below.

Irrigation rake 10′ comprises handle 17 connected to spigot 24 connected to stem 22 connected to base 32 connected to two instances of irrigation spike 45. These components are discussed below. Irrigation rake 10′ is particularly suited to indoor use, because it is short, and can be easily assembled and disassembled then stored in a bag or case kept in a cabinet or closet.

FIG. 1C shows irrigation rake 10″ which is similar to irrigation rake 10, except as discussed below.

Irrigation rake 10″ comprises handle 15 connected to stem 22′ connected to spigot 24 connected to stem 22 connected to base 31 connected to irrigation spike 47. Clamp 4 is clamped around stem 22′ and forms a support for fluid vat 1 connected to spigot 5′ connected via a hose to nozzle 23C of spigot 24. These components are discussed below. Irrigation rake 10″ is suited for delivering the contents of fluid vat 1 to plant roots.

FIG. 1D shows irrigation rake 10′″ which is similar to irrigation rake 10, except as discussed below.

Irrigation rake 10′″ comprises handle 15 connected to stem 22A connected to spigot 24A connected to base 31 connected to irrigation spike 47. Stem 22A is a longer version of stem 22, such as 40 inches in length. Spigot 24A is like spigot 24 except that spigot 24A lacks nozzle 23C.

It will be seen that (1) a spigot can be positioned near the handle (see FIG. 1B), (2) a spigot can be positioned around the midpoint of the stem of the irrigation rake (by using a stem with a screw-in spigot as shown in FIG. 1A or by positioning the spigot between two extender stems as shown in FIG. 1C), or (3) a spigot can be positioned near the base (see FIG. 1D).

Variations of the components of irrigation rake 10 will now be discussed. These components can be assembled in various configurations to create irrigation rakes ideal for a user's needs, as will be apparent to one of ordinary skill in the art. These components are generally made from stiff plastic, but other materials may be used such as but not limited to stainless steel, aluminum, powdered aluminum, other metal, ceramic, wood or bamboo. These components may be made from diverse materials, particularly spigots and flow control valves.

In the drawings, slanted parallel solid lines indicate screw threads on the outside of an object, while slanted parallel dashed lines indicate screw threads on the inside of an object. Outer threads on one component mate with inner threads on another component when screwed together. In other embodiments, instead of threaded connections, other techniques are used such as but not limited to snap-in, press fit, turn-lock or a hole with a connector.

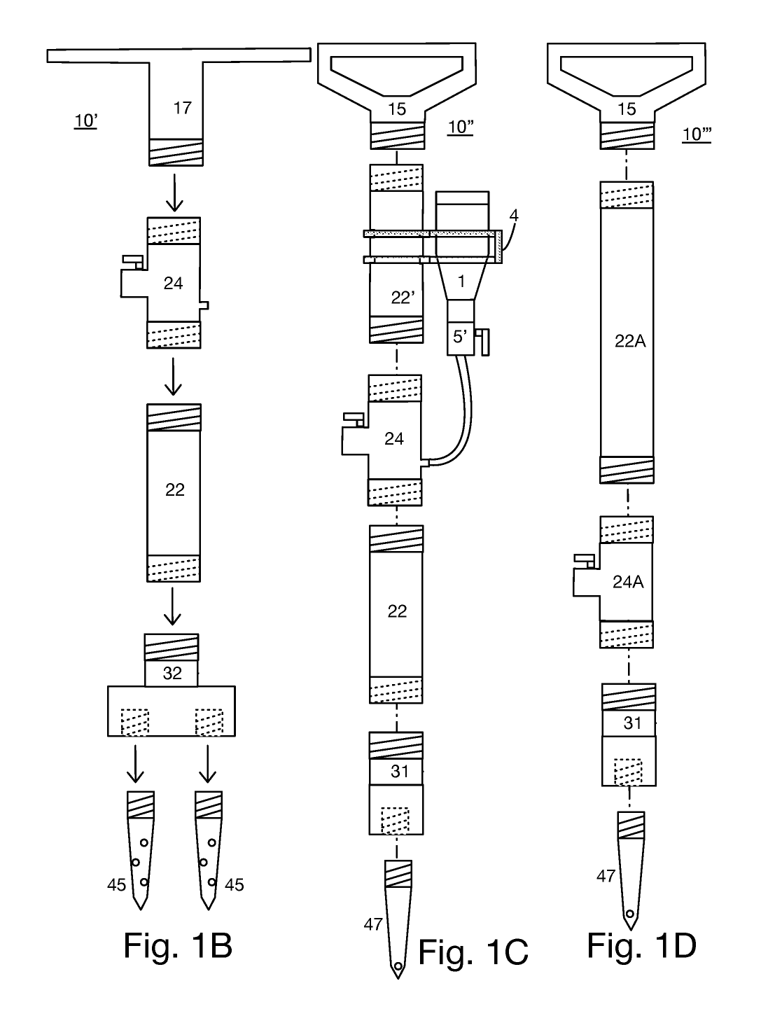

FIGS. 2A and 2B are diagrams of handles for irrigation rake 10. FIG. 2A shows handle 15, described above, with its threaded bottom visible. FIG. 2B shows handle 17, that substitutes for handle 15. Handle 15 is loop-shaped, so is convenient to hang from a hook. Handle 17 is T-shaped, so may be easier for some users to use while pushing irrigation rake 10 into soil.

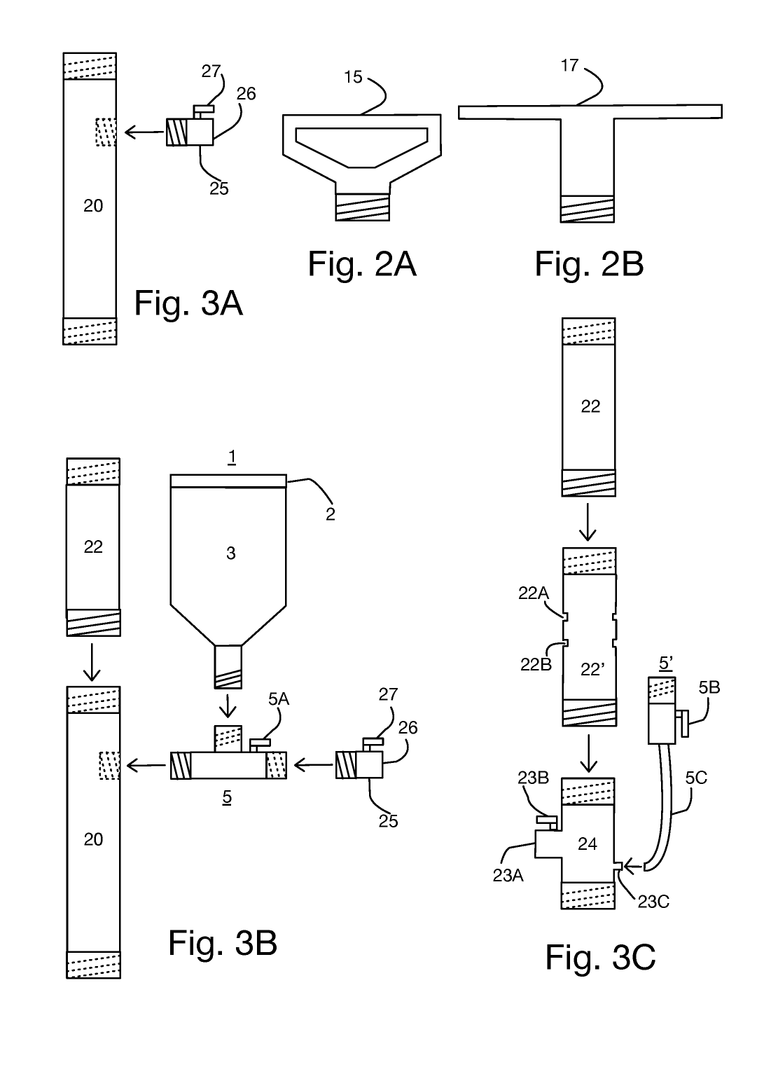

FIGS. 3A-3C are diagrams of stem configurations for irrigation rake 10.

The configuration of FIG. 3A is discussed above with regard to FIG. 1.

The configuration of FIG. 3B shows extender stem 22 used with stem 20, and shows fluid vat 1 used between stem 20 and spigot 25.

Extender stem 22 is a hollow cylinder with a diameter of about 2 inches and a length of about 6 inches, although other sizes are used in other embodiments, and having threads for screwing on the outside of one end and the inside of the other end, and can be attached to either end of stem 20 by screwing extender stem 22 onto stem 20. Multiple extender stems 22 can be used to further lengthen stem 20, so that irrigation rake 10 is a convenient height for its user.

Fluid vat 1 comprises lid 2, tank 3, inverted-T-shaped base 5 and flow valve 4. Fluid vat 1 is mainly comprised of plastic.

Lid 2 is adapted to be snapped onto and off from the open top of tank 54.

Tank 3 is desirably comprised of clear or translucent plastic, so the user can readily see how much fluid is in tank 3. Tank 3 has a bottom opening adapted to be screwed into the top of the central vertical stem of base 5. Tank 1 has a capacity of 1 gallon; other sizes are used in other embodiments.

Base 5 is a substantially hollow inverted-T shape. One end of base 5 is adapted to be screwed into the side of stem 20, while the other end of base 5 is adapted to be screwed into spigot 25. The central vertical stem of base 5 is adapted to allow the bottom opening of tank 3 to be screwed thereinto. Base 5 has flow valve 4 attached thereto for manually adjusting fluid flow from tank 3. In other embodiments, flow valve 4 is electronically operated such as via a Bluetooth signal from a smartphone or other computing device.

In some embodiments, straps are used to secure tank 3 to stem 20.

In operation, one end of base 5 is screwed into the side of stem 20, and the other end of base 5 is screwed into spigot 25. On/off valve 27 of spigot 25 is set to its closed (off) position. Tank 3 is screwed into the top of the vertical stem of base 5. If straps are available, the straps are looped around tank 3 to secure tank 3 to stem 20, minimizing the chance of pressure snapping tank 3 from base 5. Valve 4 is set to its closed position, and fluid is poured into tank 54. The fluid may be water alone, or water mixed with something such as plant food or pesticide. Lid 2 is snapped onto the top of tank 3.

If desired, irrigation rake 10 can now be used to deliver the fluid in tank 3 to soil, without connecting a garden hose to spigot 25, by inserting rake 10 into soil, setting valve 4 to allow fluid to flow from tank 3 into the soil for a suitable time duration, then setting valve 4 to its closed position, pulling rake 10 from the soil, and going to another location.

Alternatively, a garden hose (not shown) can be connected to spigot 25. After rake 10 is inserted into soil, both valves 4 and 27 are set to their open (on) positions, allowing fluid from tank 3 to mix with water from the garden hose as the water flows into the soil. After a suitable time duration, valves 4 and 27 are set to their closed (off) positions, rake 10 is pulled from the soil and moved to another location.

The configuration of FIG. 3C shows extender stem 22 coupled to stem 22′ coupled to spigot 24. Spigot 24 is hollow, generally T-shaped, and has a length of about 4 inches and a diameter of about 2 inches (other sizes are possible). Spigot 24 has opening 23A for coupling to a standard garden hose along the stem of its T-shape, optional on/off valve 23B for controlling water flow through spigot 24, and nozzle 23C (discussed below). On/off valve 23B may be manually operated, electronically operated, or able to be operated either manually or electronically. Advantages of the configuration of FIG. 3C are that some users may prefer to have a garden hose connect to the portable irrigation rake just above the base, or just under the handle (see FIG. 1B), and that the height of the stem is varied by using one or two instances of extender stem 22 (see FIGS. 1B and 1C). Depending on the chosen configuration, one of stems 22 may need to be flipped so that the component mating occurs properly (see FIG. 1C).

Spigot 24 can be considered to be a short stem with a permanently attached connector for a hose. A short instance of stem 20 with a removably attached connector for a hose functions similarly.

Stem 22′ has grooves around its perimeter, for receiving respective bands of clamp 4 (see FIG. 1C), ensuring that clamp 4 does not slide along stem 22′. In other embodiments, other means of affixing clamp 4 to stem 22′ are used.

Spigot 5′ has one threaded end for mating with the bottom of tank 3 of fluid vat 1, and another end terminating in hose 5C that connects to nozzle 23C of spigot 24. Spigot 5′ also has flow control valve 5B for adjusting the amount of fluid that flows from fluid vat 1 through hose 5C to nozzle 23C of spigot 24. Flow control valve 5B may be manually operated, electronically operated, or able to be operated either manually or electronically.

Nozzle 23C of spigot 24 has open and closed positions. The open position allows fluid to flow from nozzle 23C to the hollow center of spigot 24, and thence to irrigation spikes (not shown). The closed position is obtained by putting a cap (not shown) on nozzle 23C, or by twisting nozzle 23C to reversibly seal the opening in the side of spigot 24. Nozzle 23C is located below opening 23A, so that fluid from nozzle 23C does not escape via opening 23A.

There are four possible usage states for spigot 24. In a first state, typically used when irrigation is not occurring, no water flows through opening 23A and no fluid flows through nozzle 23C. In a second state, used for delivering only water through the irrigation rake, water flows through opening 23A and no fluid flows through nozzle 23C. In a third state, used for delivering only fluid such as plant growth fluid or pesticide, no water flows through opening 23A and fluid flows through nozzle 23C. Alternatively, in the third state, fluid vat 1 can be filled with water, so that watering can occur without an external source of water under pressure. In a fourth state, used for watering and delivering fluid such as plant food, water flows through opening 23A and fluid flows through nozzle 23C.

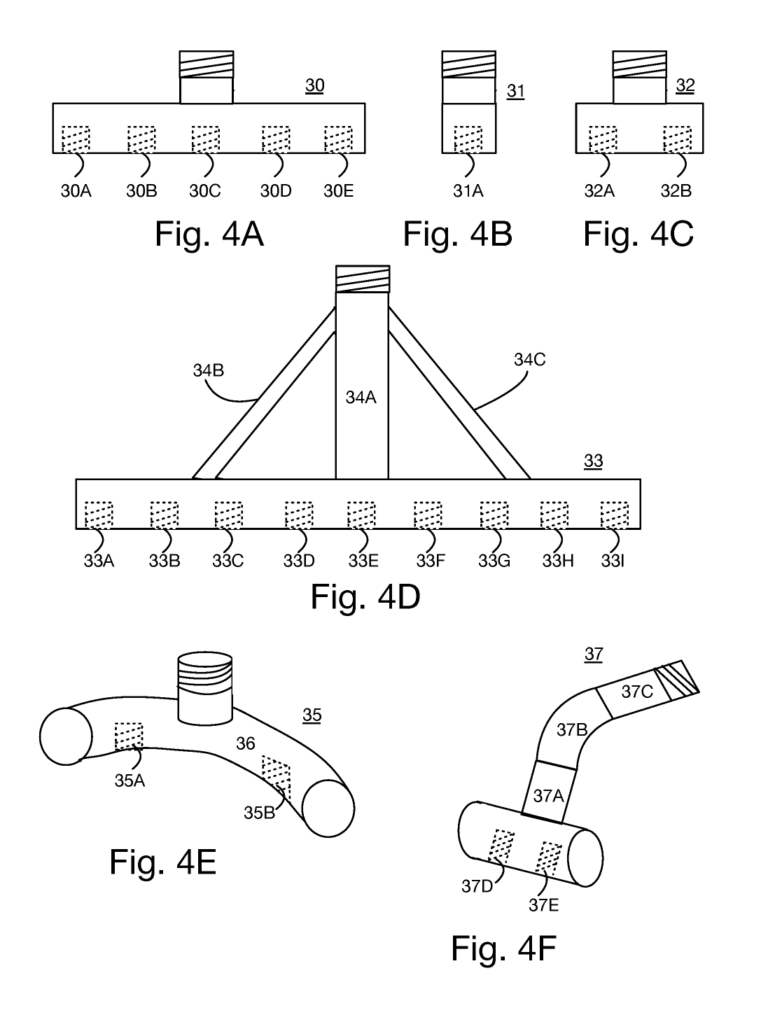

FIGS. 4A-4F are diagrams of bases for irrigation rake 10. All bases are substantially hollow and have a top portion adapted to be screwed into the bottom of stem 20. All bases have at least one threaded opening at the bottom of the base, adapted to receive a threaded top of an irrigation spike. Variations of bases other than those shown in FIGS. 4A-4F will be apparent to one of ordinary skill in the art.

FIG. 4A shows base 30 with five threaded bottom openings 30A-30E, and is discussed above with respect to FIG. 1

FIG. 4B shows base 31, which is similar to base 30, except base 31 has only one threaded bottom opening 31A.

FIG. 4C shows base 32, which is similar to base 30, except base 32 has two threaded bottom openings 31A, 31B.

FIG. 4D shows base 33, which is similar to base 30, except base 33 has nine threaded bottom openings 33A-331. Base 33 has a central vertical portion 34A, with left strut 34B providing support to the extended left side of base 33, and with right strut 34C providing support to the extended right side of base 33. In one embodiment, portion 34A is hollow and struts 34B, 34C are solid. In another embodiment, portion 34A is solid and struts 34B, 34C are hollow, encouraging fluid flow to the outer extended edges of base 33. In yet another embodiment, portion 34A and struts 34B, 34C are hollow.

FIG. 4E shows base 35, which is similar to base 32, except base 35 has a bottom portion that is arc-shaped, adapted for insertion near the outer edge of a plant pot. Plant pots typically come in standard sizes, such as 6″, 8″, 10″, 12″, 16″, 20″ diameter, and base 35 is sized to be optimal for one of the standard plant pot sizes. Different versions of base 35 are sized for different ones of the standard plant pot sizes.

FIG. 4F shows base 37, which is similar to base 32, except base 37 has a knee-shaped portion adapted for use with a hanging plant pot. The top end of segment 37C is configured to mate with stem 20, 22 or 22′, and the bottom end of segment 37C is connected to the top end of knee 37B. Knee 37B is shown as having a fixed angle of about 120 degrees; in some embodiments, knee 37B includes a hinge so that the user can adjust the angle of knee 37B. The bottom end of knee 37B is connected to the central stem of T-shaped portion 37A. The bottom (head of the T-shape) of T-shaped portion 37A has two openings 37D, 37E for receiving irrigation spikes.

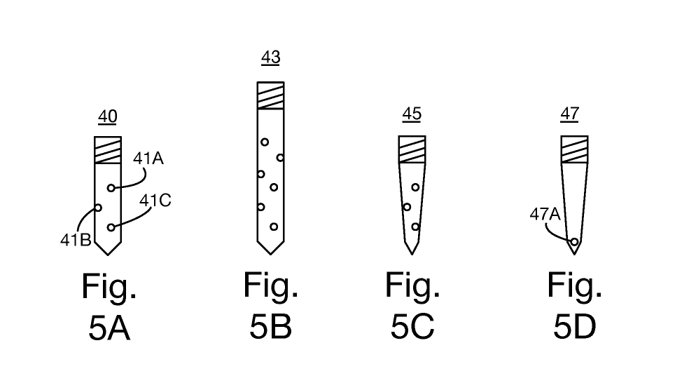

FIGS. 5A-5D are diagrams of irrigation spikes for irrigation rake 10. All irrigation spikes are substantially hollow and have a threaded top for screwing into an opening on the bottom of a base shown in FIGS. 4A-4E, a conical tip for pushing through soil, and at least one opening to enable fluid flow from the spike. Variations of irrigation spikes other than those shown in FIGS. 5A-5D will be apparent to one of ordinary skill in the art.

FIG. 5A shows irrigation spike 40, discussed above with respect to FIG. 1.

FIG. 5B shows irrigation spike 43, which is similar to irrigation spike 40, except irrigation spike 43 is longer and has more openings in its elongated sides.

FIG. 5C shows irrigation spike 45, which is similar to irrigation spike 40, except irrigation spike 45 has a tapered cylindrical shape narrowing to a conical tip, making spike 45 easier to insert in certain types of soil.

FIG. 5D shows irrigation spike 47, which is similar to irrigation spike 45, except irrigation spike 47 has only one opening 47A at its conical tip. When used with base 31 shown in FIG. 4B, irrigation spike 47 results in an irrigation rake adapted for precision delivery of fluid to a single point, which is desirable in some situations.

Irrigation rake 10 may be configured with respectively different irrigation spikes. For example, base 30 may be populated with, from left to right, spikes 43, 40, 40, 40, 43, providing extra water at the extreme edges of base 30.

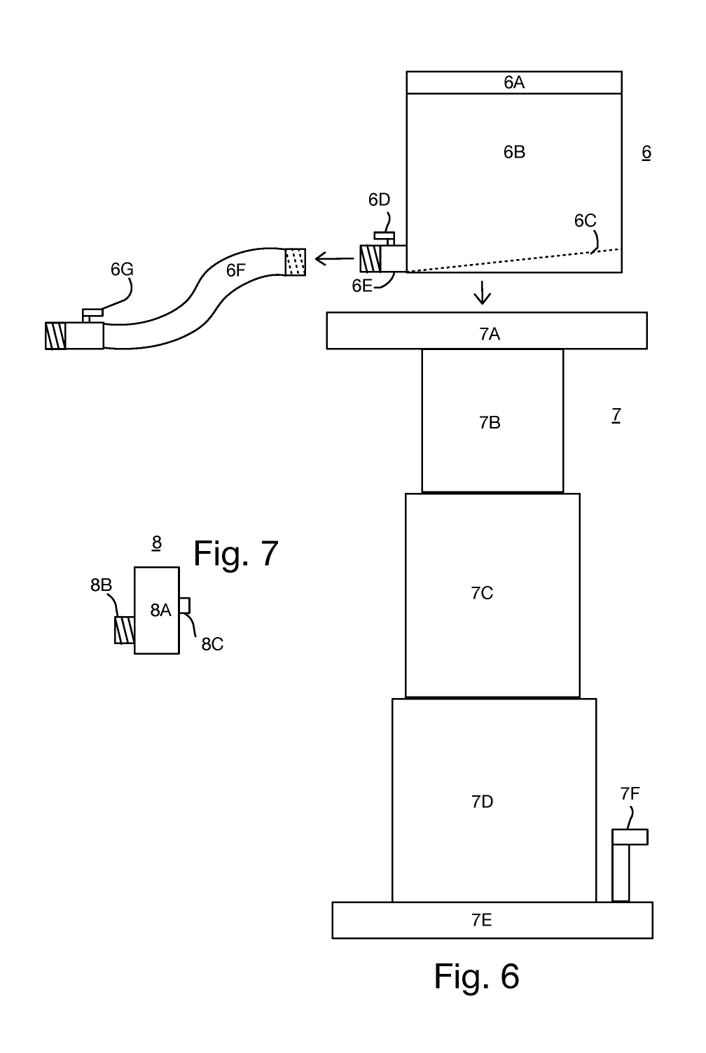

FIG. 6 is a diagram of an elevated water supply for the irrigation rake of FIG. 1, comprising water tank 6 and telescoping stand 7. In some circumstances, such as indoor use or outdoor use too remote from a water supply, there is a need to locally supply water to irrigation rake 10. The elevated water supply relies on gravity: placing water tank 6 atop telescoping stand 7 pushes water from water tank 6 to irrigation rake 10.

Water tank 6 comprises lid 6A, vat 6B with sloped internal bottom 6C, flow valve 6D, spigot 6E and hose 6F with flow valve 6G. Lid 6A removably fits atop vat 6B. Vat 6B holds about 5 gallons of water; other sizes are contemplated. Sloped internal bottom 6C ensures that all water in vat 6B readily flows out through spigot 6E. Hose 6F has a length of 20 feet and a diameter of 0.75 inches; other sizes are contemplated. Fluid vat 1, shown in FIG. 3B, may be inserted between spigot 6E and hose 6F, or between hose 6F and irrigation rake 10. Water tank 6 is formed of plastic.

Telescoping stand 7 has top surface 7A, concentric poles 7B, 7C, 7D, base 7E and crank 7F. Top surface 7A is adapted to support the bottom of water tank 6. Crank 7F is reversibly operable to move telescoping stand 7 from a closed position (not shown), wherein concentric poles 7B, 7C, 7D have bottom rims abutting base 7E, to an open position as shown in FIG. 6, wherein the bottom rim of pole 7B is about at the height of the top rim of pole 7C, and the bottom rim of pole 7C is about at the height of the top rim of pole 7D. In one embodiment, crank 7F operates a ratchet (not shown) enclosed in telescoping stand 7. Telescoping stand 7 is formed of metal or plastic.

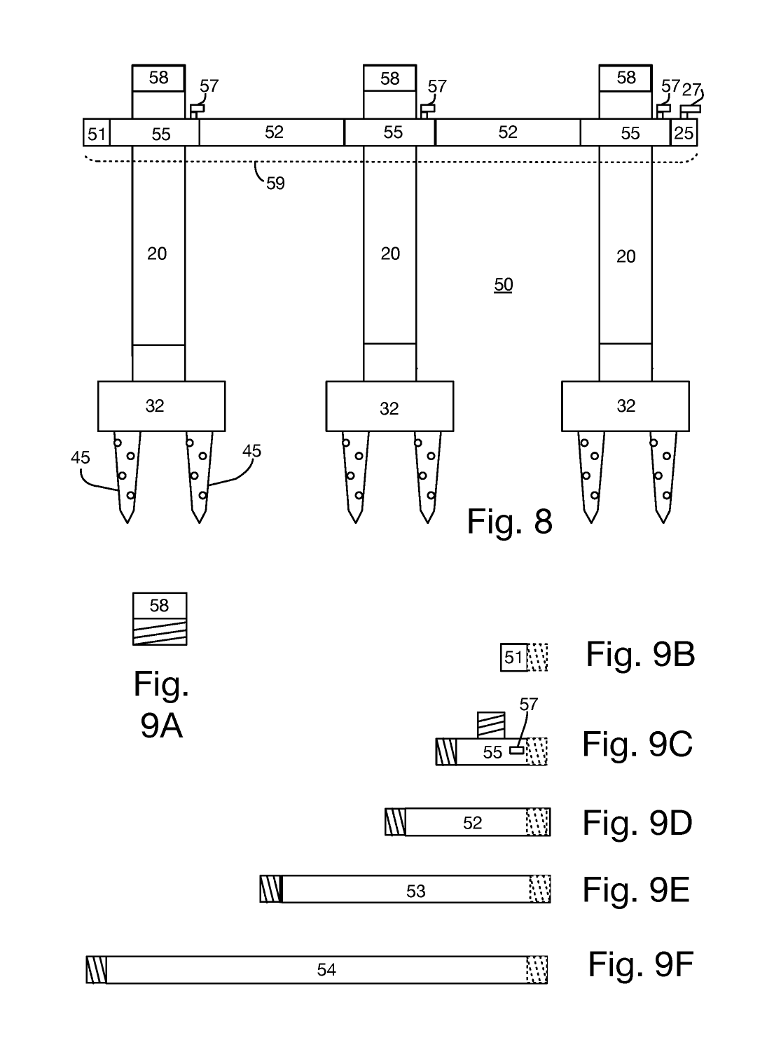

FIG. 7 is a diagram of faucet attachment 8 used with the irrigation rake of FIG. 1. When irrigation rake 10 is used indoors, it is sometimes desirable to enable water to flow directly from a kitchen sink faucet or a bathroom faucet directly to irrigation rake 10. Faucet attachment 8 is coupled to an instance of hose 6F, preferably of length 40 feet and diameter 0.75 inches, and hose 6F is coupled to irrigation rake 10. Optionally, fluid vat 1 is coupled between hose 6F and irrigation rake 10.

Faucet attachment 8 has top portion 8A, spigot 8B and relief valve 8C. Spigot 8B is located lower than relief valve 8C. Relief valve 8C may be as shown in U.S. Pat. No. 9,581,354 which opens when pressure exceeds a predetermined force. Top portion 8A is suitable for being clamped to a faucet (not shown), such as having an internal rubber ring (not shown) with a threaded screw (not shown) that is reversibly operable to reduce the diameter of the internal rubber ring to clamp onto the outside of the faucet. Water from the faucet will flow out through spigot 8B to hose 6F. If flow valve 6G of hose 6F is closed, water pressure in host 6F will eventually build enough pressure to open relief valve 8C, and water will flow into the kitchen or bathroom sink (not shown), instead of bursting hose 6F. If flow valve 6G of hose 6F is then opened, water will flow through hose 6F, reducing the pressure in faucet attachment 8 so that relief valve 8C automatically closes.

The portable irrigation rake may be connected to other irrigation rakes to create a portable irrigation system. Generally, the portable irrigation system is left in place for the growing season, typically spring to summer, then removed and stored. Compared to a permanent in-ground irrigation system, the portable irrigation system is readily removable, and easily reconfigurable to accommodate different plants and configurations from year to year. Compared to an above-ground sprinkler, the portable irrigation system uses water more efficiently, since relatively little water evaporates from the surface.

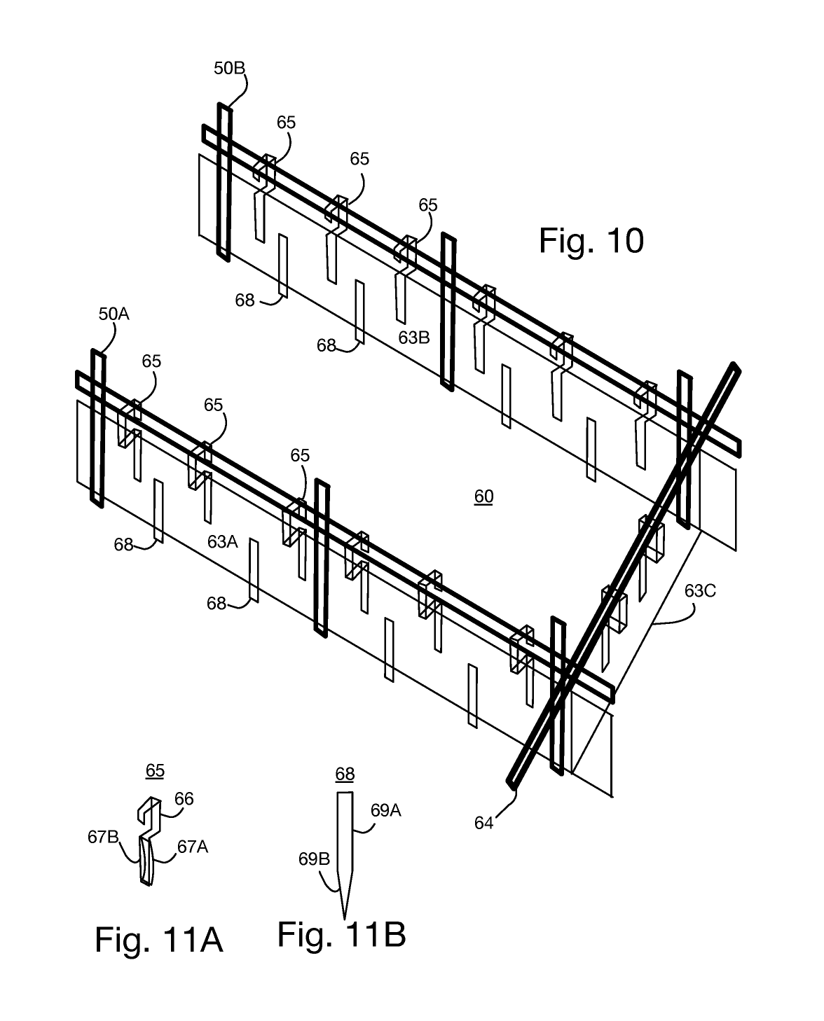

FIG. 8 is a diagram of portable irrigation system 50, showing three portable irrigation rakes connected by water distribution pipe 59. In other embodiments, other numbers of irrigation rakes are used to form a portable irrigation system.

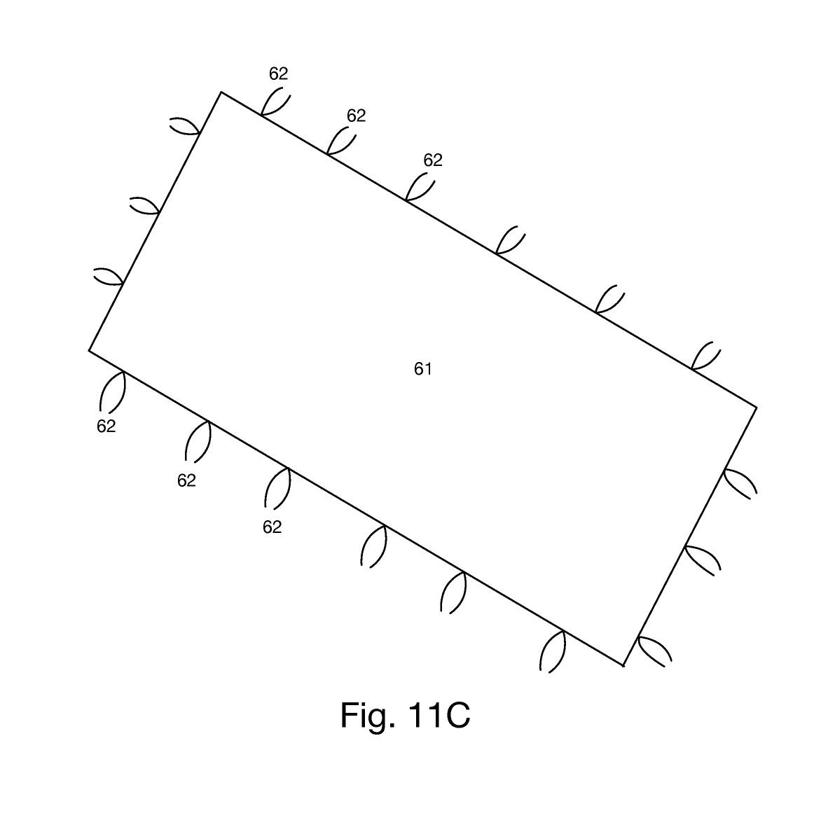

Each irrigation rake comprises stem 20, base 32 and two irrigation spikes 45, discussed above. In other embodiments, different bases and irrigation spikes are used. Handle 58, also referred to as stem cap 58, shown in FIG. 9A, is screwed onto the top of stem 20. Handle 58 has a diameter of about 2 inches and a length of about 4 inches, a threaded outside, for mating with the threaded inside of stem 20 and a flat top, to close stem 20. In some embodiments, Handle 58 is not used, and the top of stem 20 is left open. Handle 58 provides a flat surface for pushing its irrigation rake inro soil.

Water distribution pipe 59 comprises the following components, serially coupled: end cap 51, first siphon 55 with flow valve 57, first pipe 52, second siphon 55 with flow valve 57, second pipe 52, third siphon 55 with flow valve 57, and spigot 25. Spigot 25 is shown in FIG. 3A, and discussed above. The components of water distribution pipe 59 are plastic, but other materials may be used such as but not limited to stainless steel, other metal, ceramic, wood or bamboo. The components of irrigation pipe 59 may be made from the diverse materials, e.g., plastic for siphon 55 and brass for flow valve 57.

FIG. 9B shows end cap 51. End cap 51 is similar to stem cap 58, discussed above, except end cap 51 has a diameter of about 0.75 inches and a length of about 1.5 inches. End cap 51 functions to provide a closed end to water distribution pipe 59, ensuring that water is delivered to plant roots via portable irrigation system 50, and preventing water from being delivered to the top of the ground soil.

FIG. 9C shows siphon 55. Siphon 55 is a hollow T-shaped tubular component having a diameter of about 0.75 inches, with each arm of the T-shape having a length of about 2.5 inches. One arm of siphon 55 is for coupling to stem 20, and functions to siphon water from water distribution pipe 59 to stem 20. The other arms of siphon 55 are for coupling to respective instances of pipe 52. Siphon 55 has flow valve 57 for controlling the size of the opening in the arm leading to stem 20, thereby controlling the amount of water siphoned from water distribution pipe 59 to stem 20 and thence to the plant roots surrounding irrigation spikes 45 coupled via base 32 to stem 20.

FIG. 9D shows pipe 52. Pipe 52 is a hollow pipe having a diameter of about 0.75 inches and a length of about 20 inches.

FIGS. 9E and 9F show pipes 53 and 54, that are similar to pipe 52, except have a different length. In one embodiment, pipe 53 has a length of about 40 inches and pipe 54 has a length of about 60 inches. Pipes 53 and 54 can be substituted for pipe 52 in portable irrigation system 50, so that the size of the irrigation system suits the configuration of plants.

In operation, portable irrigation system 50 is placed in the ground by inserting irrigation spikes 45 entirely into the soil, and a garden hose (not shown) is connected to spigot 25. The faucet feeding water to the garden hose is turned on, on/off valve 27 is set to its open position, and water flows into water distribution pipe 59. Each respective flow valve 57 is set to a desired opening; typically, a smaller opening closer to spigot 25 and a larger opening closer to end cap 51, so that the amount of water flowing to each stem 20 is approximately equal. Generally, portable irrigation system 50 is left in the ground for the duration of growing season.

Multiple instances of portable irrigation system 50 may be used together to create a portable irrigation and fencing system, to protect plants from animals that eat or harm the plants. An optional sun shade protects plants from direct sunlight.

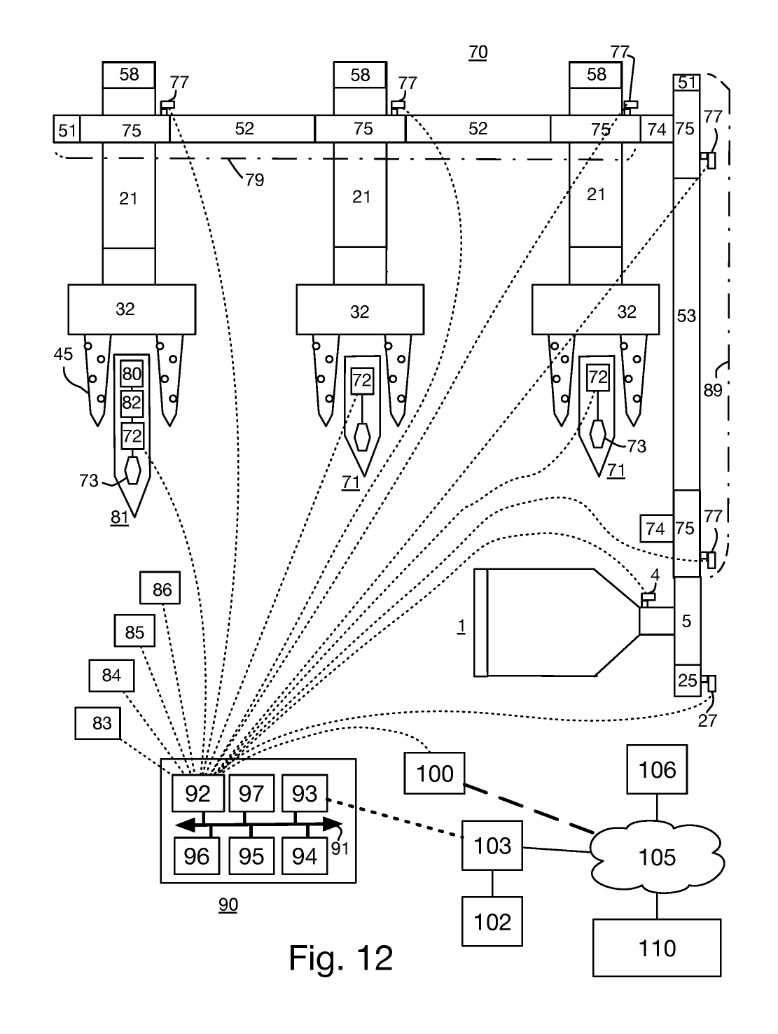

FIG. 10 is a diagram of a portion of portable irrigation and fencing system 60, inserted in the ground.

Portable irrigation system 50A is an instance of portable irrigation system 50, described above with respect to FIG. 8, and is used on the west side of an area to be irrigated. West wall 63A hangs like a curtain, via hooks 65 hanging from the water distribution pipe of portable irrigation system 50A.

Portable irrigation system 50B is an instance of portable irrigation system 50, described above with respect to FIG. 6, and is used on the east side of an area to be irrigated. East wall 63B hangs like a curtain, via hooks 65 hanging from the water distribution pipe of portable irrigation system 50B.

End bar 64 is used on the south side of an area to be irrigated. End bar 64 is a hollow plastic pipe; in other embodiments, end bar 54 is a wooden plank, a chain, a rod or other element suitable for suspending hooks 65 that, in turn, support south wall 63C. End bar 64 rests on the water distribution pipes of irrigation systems 50A and 50B, and is affixed thereto with a suitable mechanism, such as string, plastic ties, metal clamp, or U-shaped cutouts in end bar 64 that enable end bar 64 to be hooked onto the water distribution pipes of irrigation systems 50A and 50B. End bar 64 is an appropriate size for the area to be irrigated, such as 60 inches length and 0.75 inches diameter.

The north end of the area to be irrigated is shown as open, suitable when the wall of a house, garage or shed is present. In other embodiments, an end bar (not shown) similar to end bar 64 is provided, along with a north wall similar to south wall 63C.

Each of west wall 63A, east wall 63B and south wall 63C is essentially a rectangle of an animal-resistant mesh material, formed of suitable material such as stiff plastic, metal or even braided twine. Assuming pipes 53, shown in FIG. 7E and having length 40 inches, are used in each of irrigations systems 50A, 50B, then each of west wall 63A and east wall 63B has a size of about 90 inches length by 36 inches height, and south wall 63C has a size of about 50 inches length by 36 inches height. In other embodiments, other wall sizes are used.

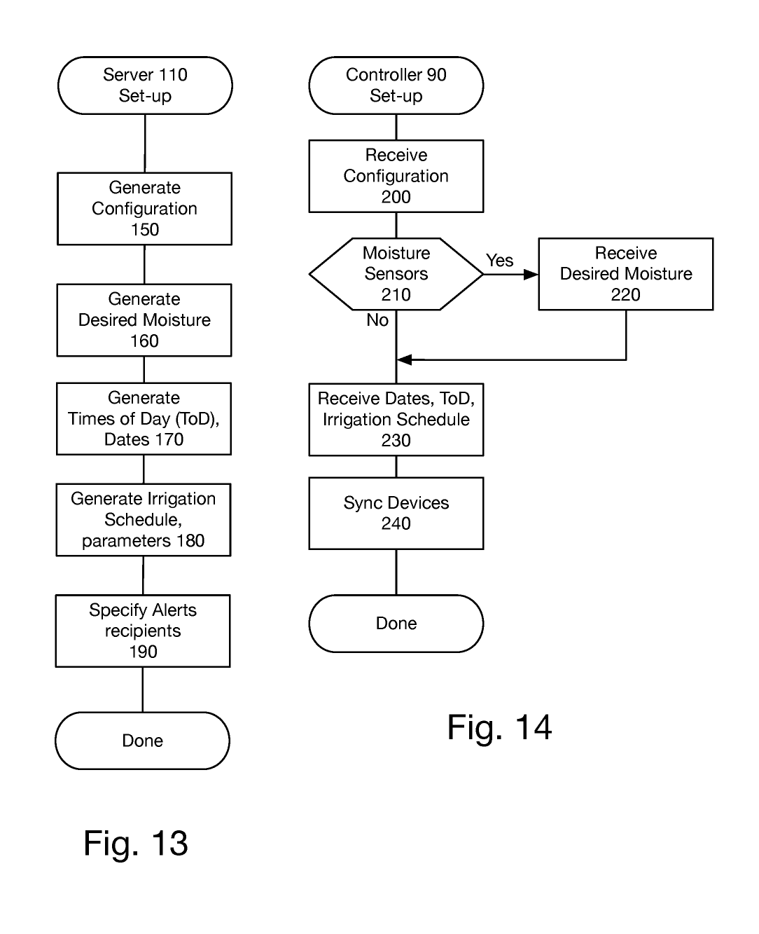

FIG. 11A shows hook 65. Hook 65 has top portion 66 and bottom flaps 67A and 67B. Top portion 66 has a rectangular or circular shape with a cut-out enabling top portion 66 to be hooked around pipe 53 or end bar 64 and hang therefrom, like a shower curtain. Bottom flaps 67A and 67B project from the bottom of top portion 66. The inner sides of flaps 67A and 67B are adapted to mate with each other, such as having male snap portions on flap 67A and female snap portions on flap 67B, or velcro-type hooks on flap 67A and velcro-type loops on flap 67B. Hook 65 is formed of plastic. In other embodiments, hook 65 is formed of metal.

To use hook 65, (i) bottom flaps 67A and 67B are manually separated, (ii) the top edge of a wall, such as west wall 63A, east wall 63B or south wall 63C, is placed between flaps 67A and 67B, (iii) flaps 67A and 67B are pushed together so that their inner portions mate, and (iv) top portion 66 is hung from pipe 53 or end bar 64.

Optional stabilizing stakes 68 are placed at intervals along the bottom of west wall 63A, east wall 63B and south wall 63C, to help keep walls 63A, 63B, 63C aligned on the perimeter of the area to be irrigated.

FIG. 11B shows stabilizing stake 68. Stabilizing stake 68 has broad flat upper portion 69A adapted to serve as a guidepost for one of walls 63A, 63B, 63C, and spike 69B projecting beneath upper portion 69A for inserting stake 68 into soil. Stabilizing stake 68 is made of a firm material such as plastic or metal. Stabilizing stake has a length of about 15 inches, a width of about 3 inches, and a thickness of about 0.5 inches. In other embodiments, different sizes are used.

FIG. 11C shows sun shade 61. Sun shade 61 is generally rectangular and formed of a suitable material for filtering direct sunlight such as gauze or plastic mesh. Sun shade 61 has a size of about 90 inches by 50 inches; other sizes are used in other embodiments. Around the perimeter of sun shade 61, there are sets of ties 62 at intervals of about 15 inches. Each of ties 62 is formed of two pieces of string, or plastic, about 6 inches long, attached at one end to sun shade 61.

In use, ties 62 are separated, then tied around pipe 53 or end bar 64, so that sun shade 61 serves as a roof over the area to be irrigated.

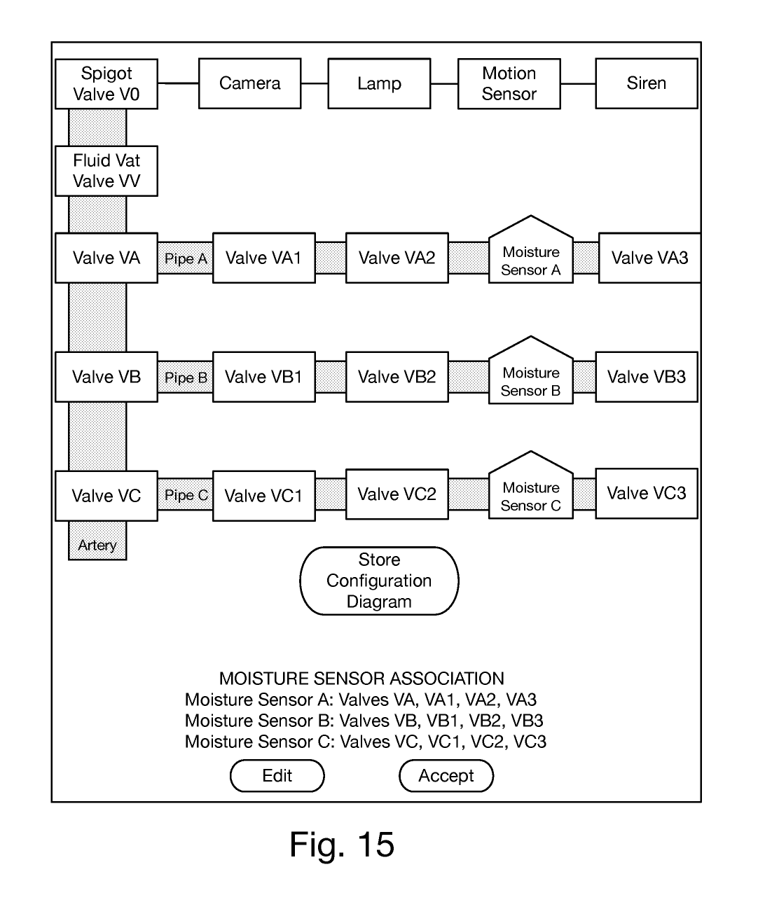

FIG. 12 shows portable irrigation system 70, similar to portable irrigation system 50 in FIG. 8; for brevity, only differences are discussed. Portable irrigation system 70 is intended to be left in the ground during the growing season. Sensors sense soil moisture, and a controller controls the amount of water delivered based on the sensed moisture and a specified desired moisture range. Portable irrigation system 70 embodies an Internet of Things approach to gardening.

Sensor stake 71 includes moisture sensor 73 near its bottom. Moisture sensor 73 may be a pair of electrodes as described in U.S. Pat. No. 8,981,946. Moisture sensor 73 is coupled to communication circuit 72 to obtain power from communication circuit 72, and to provide sensor readings to communication circuit 72. Communication circuit 72 includes a power source, such as a battery. Communication circuit 72 operates according to a suitable low power protocol such as Bluetooth, to receive requests for sensor readings from controller 90, and to provide readings from moisture sensor 73 to controller 90. Sensor stake 71 encloses communication circuit 72 in a waterproof manner. Sensor stake 71 is made of plastic, and has length of about 10 inches and width of about 2 inches. Each sensor stake 71 is placed in the soil so that moisture sensor 73 is about 6 inches from the tips of irrigation spikes 45 for a respective portable irrigation rake, in a radial direction.

Sensor stake 81 is similar to sensor stake 71, except that sensor stake 81 includes photovoltaic panel 80 and capacitor 82 coupled thereto in place of a battery. Photovoltaic panel 80 serves to convert solar energy into electricity, and to supply the electricity to capacitor 82. Capacitor 82 functions to store electricity from photovoltaic panel 80, and to provide the electricity to communication circuit 72.

In other embodiments, sensor stakes also include other sensors, such as chemical sensors for deciding when to provide plant food via irrigation system 70.

Stem 21 is similar to stem 20 of FIG. 6, except that stem 21 is shorter: about 12 inches in height, so that irrigation system 70 has less chance of its components toppling.

Siphon 75 is similar to siphon 55 of FIG. 6, except that siphon 75 is configured to operate with flow valve 77.

Flow valve 77 is similar to flow valve 57 of FIG. 6, except that flow valve 77 is able to be electronically operated via a wireless control signal from controller 90.

Water distribution pipe 79 is similar to water distribution pipe 59 of FIG. 6.

Optional pipe 74 is similar to pipe 52 of FIG. 6, except that pipe 74 is shorter, such as 6 inches. Pipe 74 couples water distribution pipe 79 to water distribution artery 89. In some embodiments, water distribution pipe 79 is coupled directly to water distribution artery 89.

In configurations where only one water distribution pipe is needed, water distribution pipe 79 couples directly to spigot 25. In portable irrigation system 70, there are two water distribution pipes (only one is shown), so water distribution artery 89 is interposed between spigot 25 and water distribution pipe 79.

Water distribution artery 89 comprises an instance of end cap 51 coupled to a first siphon 75 coupled to pipe 53 coupled to a second siphon 75. End cap 51 and pipe 53 are discussed above with respect to FIG. 6. Second siphon 75, forming one end of water distribution artery 89, is coupled to one end of base 5 of fluid vat 1. The other end of base 5 is coupled to spigot 25. Fluid vat 1 is discussed above with regard to FIG. 3B.

Flow valve 4 of fluid vat 1 and on/off valve 27 of spigot 25 are responsive to a wireless control signal from controller 90.

First siphon 75 of water distribution artery 89 is coupled to water distribution pipe 79.

Second siphon 75 of water distribution artery 89 is coupled to a second instance (not shown) of water distribution pipe 79. It will be understood that irrigation system 70 generally includes two instance of irrigation system 50 (except with differences noted), typically configured parallel to each other as shown in FIG. 8.

The fencing shown in FIG. 8 can be used with portable irrigation system 70, if stems 20 instead of stems 21 are used in portable irrigation system 70.

The sun roof shown in FIG. 9C can be used with portable irrigation system 70.

If additional instances of irrigation system 50 are desired, additional siphons are provided in water distribution artery 89, for coupling to the water distribution pipe of the respective irrigation system 50.

Portable irrigation system 70 includes lamp 83, camera 84, siren 85, motion sensor 86 and controller 90. In some embodiments, two or more of lamp 83, camera 84, siren 85, motion sensor 86 and controller 90 are combined into one device.

Portable irrigation system 70 is configured to operate with at least one of smartphone 100 and personal computer 102, which in turn operate with Internet 105 and server 110.

Lamp 83 is a waterproof light or lights suitable for outdoor use, such as an LED fixture, or LED strip. Lamp 83 includes a low-power communication interface such as a Bluetooth interface, and a power source, such as a battery or a photovoltaic panel and capacitor. An ilumi Outdoor Bluetooth Smart LED BR30 with battery operated socket, available at amazon.com, or Koopower battery operated LED string lights, also available at amazon.com, are examples of lamp 83. Lamp 83 is turned on and off via a lamp control signal from controller 90. Lamp 83 is mounted, such as on a shed or garage or pole, to illuminate the area being irrigated.

Camera 84 is a waterproof camera including a low-power communication interface such as a Bluetooth interface, and a power source, such as a battery or a photovoltaic panel and capacitor. A Turcom TS-626 WiFi Outdoor Bullet Security Camera, available at amazon.com, is an example of camera 84. Camera 84 is turned on and off via a camera control signal from controller 90. Camera 84 is mounted, such as on a shed or garage or pole, to capture an image of the area being irrigated.

Siren 85 is a waterproof noise emitting device including a low-power communication interface such as a Bluetooth interface, and a power source, such as a battery or a photovoltaic panel and capacitor. A Pyle Bluetooth Megaphone PMP42BT, available at amazon.com, is an example of siren 85. Siren 85 is turned on and off via a siren control signal from controller 90. Siren 85 is mounted, such as on a shed or garage or pole, to emit noise towards the area being irrigated.

Motion sensor 86 is a motion sensing device including a low-power communication interface such as a Bluetooth interface, and a power source, such as a battery or a photovoltaic panel and capacitor. Motion sensor 86 is turned on and off via a motion sensor control signal from controller 90. Motion sensor 86 is mounted, such as on a shed or garage or pole, to sense motion in and around the area being irrigated. The Defiant Outdoor LED Bluetooth Motion Security Light DFI-5985-WH, available at amazon.com, is an example of motion sensor 86 and lamp 83 combined into one device.

Controller 90 comprises bus 91, low-power communication interface 92, medium-power communication interface 93, processor 94, memory 95, storage 96 and power supply 97, all enclosed in a waterproof housing. Controller 90 is mounted, such as on a shed or garage or pole, at or near the area being irrigated.

Bus 91 functions to enable the components of controller 90 to communicate with each other.

Low-power communication interface 92, such as a Bluetooth interface, is operative to allow controller 90 to wirelessly communicate with on/off valve 27, flow valve 4, flow valves 77, sensor stakes 71, 81, lamp 83, camera 84, siren 85, motion sensor 86, and optional smartphone 100.

Medium-power communication interface 93, such as a WiFi interface, is operative to allow controller 90 to wirelessly communicate with WiFi router 103.

Processor 94 is adapted to allow controller 90 to control on/off valve 27, flow valve 4, flow valves 77, lamp 83, camera 84, siren 85, in response to a controller software program, discussed below.

The controller software program functions to operate on/off valve 27 and flow valves 77 to provide irrigation. If fluid vat 1 is present, the controller software program functions to mix fluid from fluid vat 1 with water arriving from spigot 25, so that fluid-enriched water is used for irrigation. If any of lamp 83, camera 84, siren 85, and motion sensor 86 are present, the controller software program functions to operate these components as described below.

Memory 95 is adapted to serve as a cache for processor 94.

Storage 96 is adapted to store the controller software program, data used by the controller software program, and data received from sensor stakes 71, 81, camera 84 and motion sensor 86.

Power supply 97 is adapted to provide power to controller 90. In one embodiment, power supply 97 is a battery or batteries. In another embodiment, power supply 97 is a capacitor storing charge provided by a photovoltaic panel mounted on the enclosure of controller 90, with battery back-up.

Smartphone 100 is a wireless device capable of Internet operation, such as an Apple iphone or Apple ipad running the iOS operating system, or a device running the Android operating system. Smartphone 100 is operative to communicate with controller 90 via a low-power communication protocol such as Bluetooth, and to communicate with server 110 via public communication network 105, such as the Internet, using a cellular communication protocol from a cellular service provider such as Verizon, AT&T, T-Mobile or Sprint. In some embodiments, smartphone 100 runs an app downloaded from an app store to communicate with controller 90 and/or server 110.

Personal computer 102 is a general purpose personal computer or laptop computer operative to communicate with server 110 via WiFi router 103, an Internet service provider and Internet 105, and with controller 90 via WiFi router 103.

WiFi router 103 is operative to communicate with controller 90 and personal computer 102 via a medium range protocol such as WiFi, and to communicate via a direct line to an Internet service provider, using a suitable technique such as data over voice.

Weather service 106 is a server operative to send weather information, such as rain forecasts and rain reports, to server 110 via Internet 105.

Server 110 is a web site operative according to a server software program, discussed below. Server 110 is a general purpose computer including a processor, memory, storage and communication interface to send and receive messages via Internet 105.

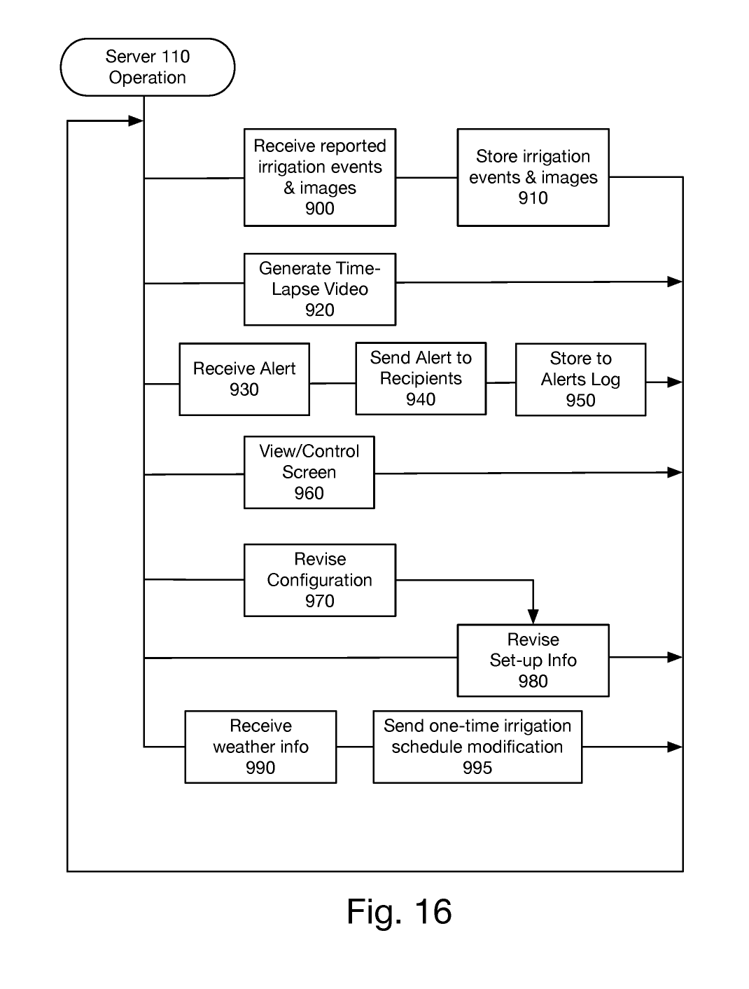

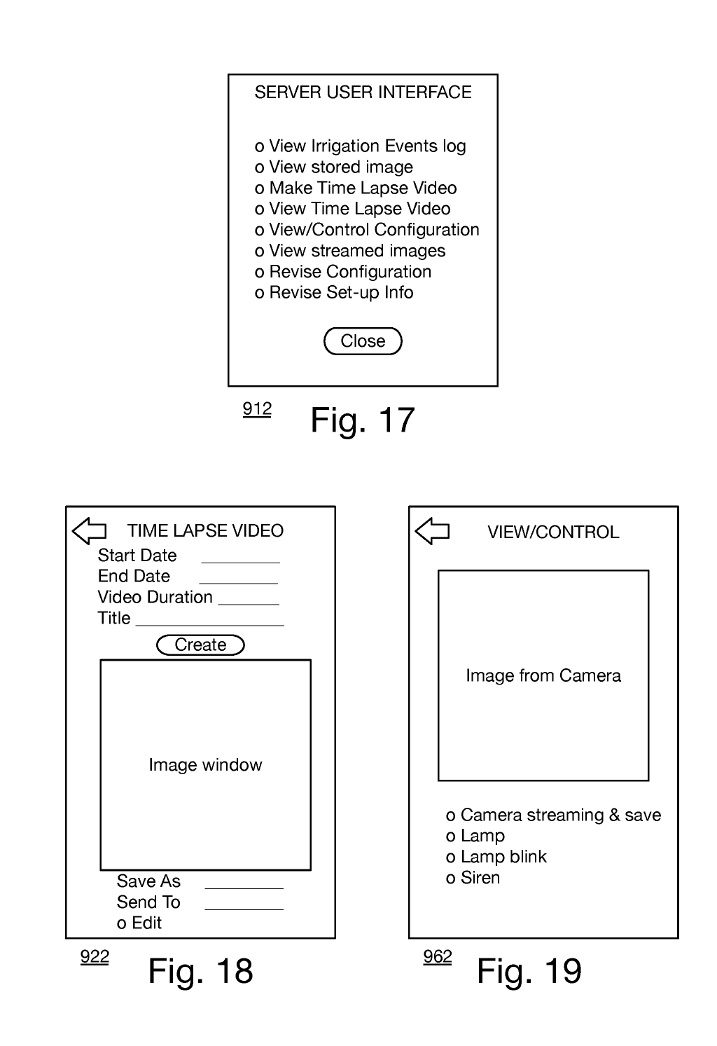

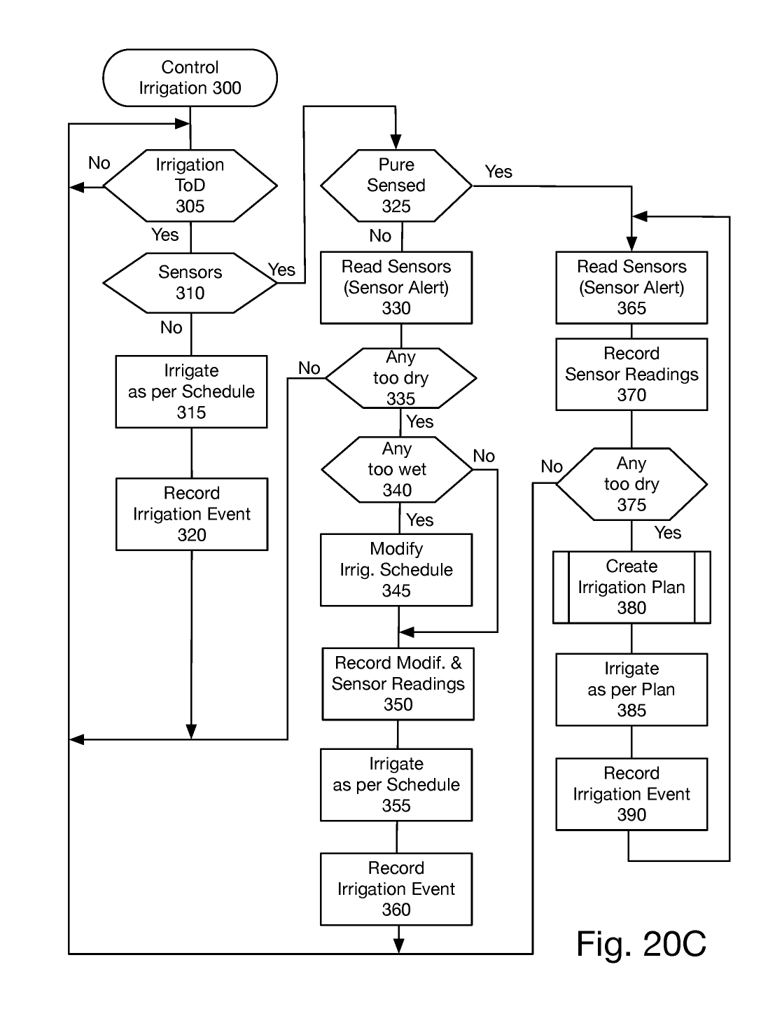

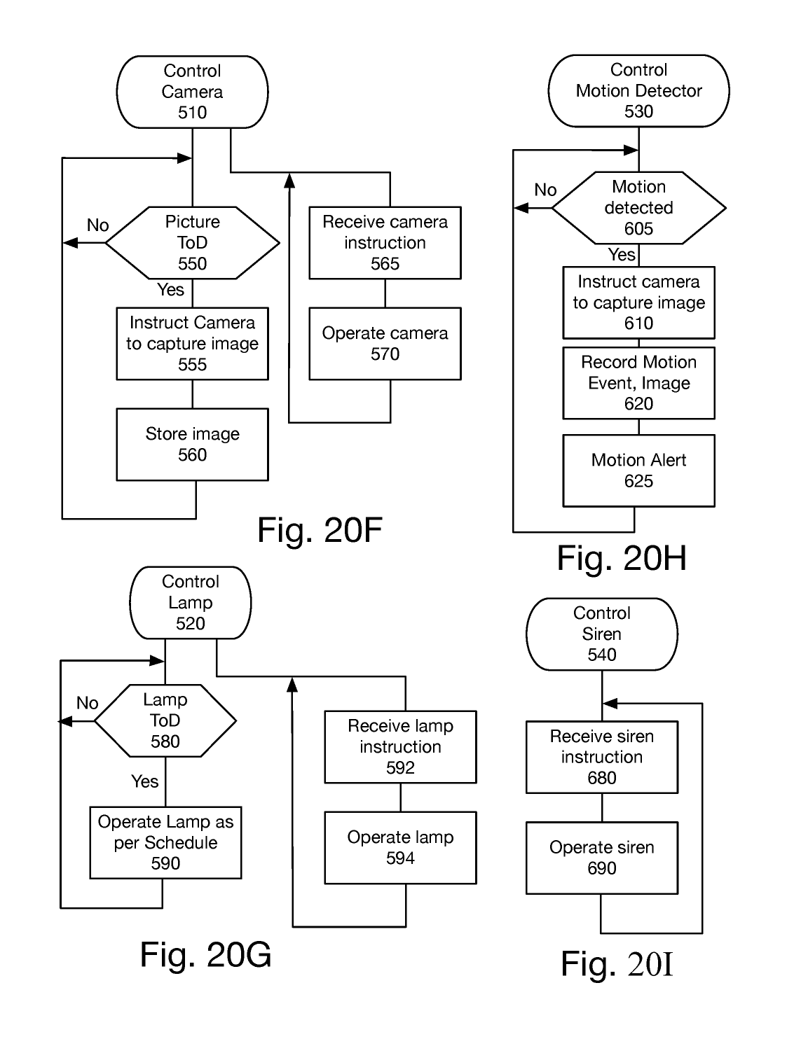

The software program for server 110 and the software program for controller 90 will now be discussed. Each of these programs has a set-up phase and an operational phase. FIGS. 13 and 14 respectively show the set-up phases for server 110 and controller 90, while FIGS. 16 and 20 respectively show the operational phases for server 110 and controller 90.

FIG. 13 is a flowchart for server software set-up. Let it be assumed that a user has registered at server 110 by creating an account with a unique account name, such as an email address, and a password. The user uses smartphone 100 or personal computer 102 to communicate with server 110.

At step 150, the user generates a configuration for her/his irrigation system, and the server software stores the irrigation configuration at server 110. The server software provides a graphical user interface enabling the user to drag and drop irrigation system components. If there are moisture sensors, server 110 attempts to associate flow valves with the moisture sensors. This association is important for irrigation: the valves associated with a moisture sensor are controlled in accordance with the readings from the moisture sensor. Ideally, there will be one moisture sensor per valve, but some users may wish to economize and purchase fewer moisture sensors. In some embodiments, sensors for different characteristics are present, such as chemical sensors used to determine when plant food should be provided, in a similar manner as plain water irrigation discussed herein.

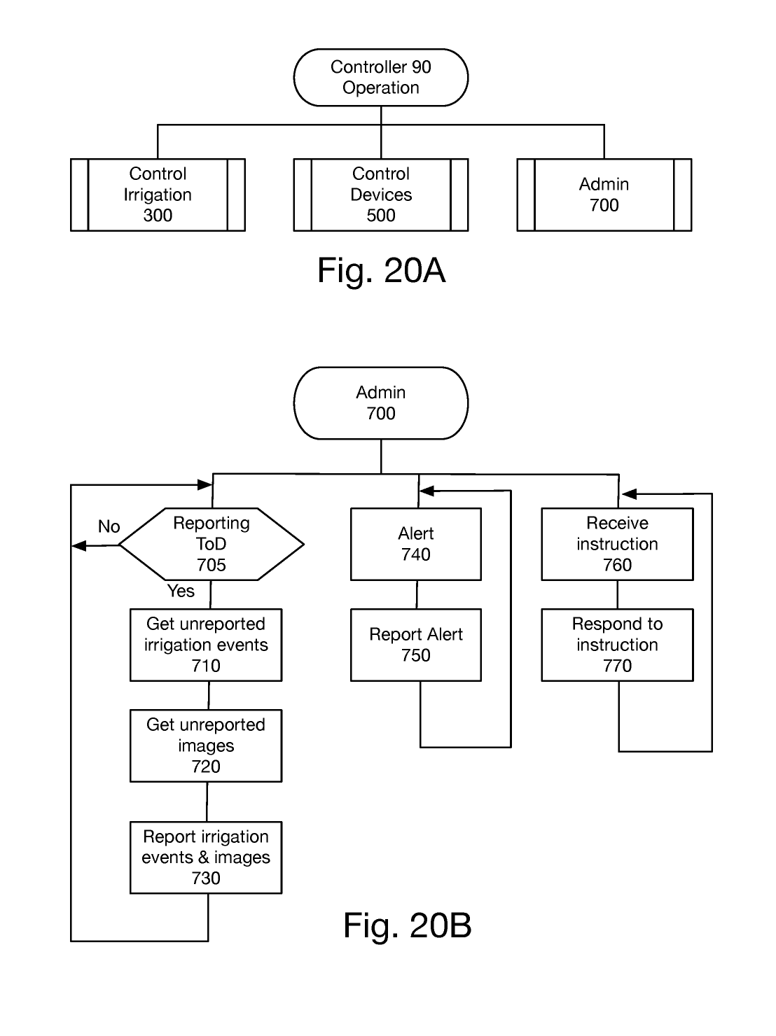

FIG. 15 is a diagram of a graphical user interface showing an exemplary irrigation configuration diagram created using server 110. The upper left component is always spigot valve V0, receiving water from a garden hose or water tank 6 shown in FIG. 6. Non-irrigation devices, such as a camera, lamp, motion sensor and siren, are dragged onto a horizontal line extending to the right (eastward) of spigot valve V0. There can be multiple instances of a particular non-irrigation device, such as multiple cameras. If there is a water distribution artery, as in this example, it is dragged to extend from the bottom (southward) of spigot valve V0. Then, the water distribution artery is populated, in this example, with fluid vat valve VV, and artery valves VA, VB, VC. A water distribution pipe is dragged to extend horizontally from each artery valve, referred to as water distribution pipes A, B, C. In this example, each water distribution pipe is populated, by dragging and dropping, with three valves and one moisture sensor. Element identifiers are automatically assigned when an element is dropped onto the configuration diagram. When the user is satisfied with the configuration diagram, she/he actuates the “Store Configuration Diagram” button, such as by clicking on it.

Immediately after storing the irrigation configuration, server 110 creates an association between the moisture sensors and the valves in the configuration diagram (one moisture sensor per flow valve), other than valve V0 and VV, and displays this association proximate to the configuration diagram. If the user accepts the association, such as by clicking on an Accept button, then server 110 stores the association between moisture sensors and valves with the configuration diagram. Otherwise, the user can edit the association, such as by clicking on an Edit button, until she/he is satisfied, then accepts by clicking on the Accept button, and the edited association is stored with the configuration diagram.

Let it be assumed that water distribution pipe A corresponds to a row of flowering plants (generally thirsty plants), water distribution pipe B corresponds to a row of succulent plants (plants thriving with moderate watering), and water distribution pipe C corresponds to a row of cacti (drought tolerant plants).

At step 160, if there are moisture sensors in the irrigation configuration, the user provides a desired moisture range for each moisture sensor, and the server software stores the desired moisture range data. For example, when 0 corresponds to dry soil, and 1 corresponds to flooded soil, for the irrigation configuration of FIG. 15, the user provides desired moisture ranges as follows: moisture sensor A: 0.5-0.7, moisture sensor B: 0.3-0.5, moisture sensor C: 0.2-0.3.

At step 170, the users provides the dates and time(s) of day, if any, for automatically operating suitable components of the configuration, and the server software stores this data. For example, valves V0-VV and moisture sensors A-C: May 15-October 15, 6 am and 6 pm; camera: daily, 6:30 am, 9:30 am, 12:30 pm, 3:30 pm; lamp: daily, 10 pm-2 am.

At step 180, the user provides an irrigation schedule and irrigation parameters including whether server 110 should automatically modify the irrigation schedule based on weather information, and the server software stores this data. In this example, the flow amount for each valve is set by the user to either 0 (off) or a number between 0 and 1 (on), then controller 90 controls each valve to be on or off. Generally, a value of 1 is used for the valve furthest from the water source, and lower values are used for the valves closest to the water source, to adjust for the fact that water pressure, and thus the amount of water delivered via each portable irrigation rake, is highest nearest the water source. The user can change these parameters at any time. For example, for the configuration of FIG. 15, irrigation parameters are, for the “on” values of the valves: V0=1.0, VV=0.5,

VA=1.0, VB=1.0, VC=1.0,

VA1=0.3, VA2=0.5, VA3=1.0,

VB1=0.3, VB2=0.5, VB3=1.0,

VC1=0.3, VC2=0.5, VC3=1.0,

and a sample irrigation schedule is:

V0, VV=(T0) to (T0+27 minutes),

VA, VA1, VA2, VA3=(T0) to (T0+15 minutes),

VB, VB1, VB2, VB3=(T0+15 minutes) to (T0+23 minutes),

VC, VC1, VC2, VC3=(T0+23 minutes) to (T0+27 minutes).

The sample irrigation schedule corresponds to first watering the flowering plants row for 15 minutes, then watering the succulents row for 8 minutes, then watering the cacti row for 4 minutes.

It is desirable to have at least one moisture sensor to prevent watering while it is raining.

If there are moisture sensors, the user may specify dynamic or hybrid irrigation. Dynamic irrigation, also referred to as “pure sensed” irrigation, comprises watering until the desired moisture is sensed at each sensor. Hybrid irrigation comprises watering according to a schedule only if the sensed moisture is below the desired range. Dynamic and hybrid irrigation are discussed below with respect to FIG. 20C.

If there are no moisture sensors in the user's irrigation configuration, then the user is more likely to authorize server 110 to modify the irrigation schedule based on weather information. For instance, the user may, via a graphical user interface, check radio buttons corresponding to which if the following rules that the user wants server 110 to adopt for the user's irrigation configuration: (a) if a rain report is received for my area, then do not irrigate during the next 24 hours; (b) if a rain forecast is that the probability of rain for my area is at least 80%, then do not irrigate during the next 12 hours; (c) if a rain forecast is that the probability of rain for my area is at least 50%, then reduce the irrigation amount in my irrigation schedule by 50% during the next 12 hours. Server 110 may also allow the user to define her/his own rule(s) for irrigation, and instruct server 110 to use the user-defined rules to modify the user's irrigation schedule.

If there are moisture sensors in the user's irrigation configuration, then the user may authorize server 110 to modify the irrigation schedule or plan determined by controller 90 according to one or more of the following rules: (a) if a rain forecast is that the probability of rain for my area is at least 80%, then do not irrigate during the next 12 hours; (b) if a rain forecast is that the probability of rain for my area is at least 50%, then reduce the irrigation amount in my irrigation schedule or plan by 50% during the next 12 hours. Server 110 may also allow the user to define her/his own rule(s) for irrigation, and instruct server 110 to use the user-defined rules to modify the user's irrigation schedule or plan.

At step 190, the user specifies the address(es) of device(s) that should receive alerts, including sensor broken alerts, and motion detected alerts. In this example, let it be assumed that the user specifies the telephone number of smartphone 100, and an email address, as alert recipients.

Set-up of server 110 is now complete.

FIG. 14 is a flowchart for controller software set-up.

At step 200, the user configures controller 90 to communicate with server 110 by providing initialization data to controller 90. Initialization data comprises the current date and time at the location of controller 90, the WiFi network name and password for WiFi router 103, and the user's unique account name for server 110 and password. The controller software is adapted to receive initialization data via a low-power protocol, such as a Bluetooth channel to smartphone 100 or a Bluetooth channel (not shown) to personal computer 102.

The controller software uses the initialization data to communicate with server 110, and requests an irrigation configuration. Server 110 sends the irrigation configuration generated at step 150 of FIG. 13 to controller 90, and controller 90 stores the irrigation configuration.

At step 210, controller 90 checks whether there are any moisture sensors in the irrigation configuration. If so, at step 220, controller 90 asks server 110 for the moisture range data and the association between the moisture sensors and valves (see bottom of FIG. 15), and server 110 sends (i) the association data generated at step 150 of FIG. 13, and (ii) the moisture range data generated at step 160 of FIG. 13, to controller 90, and controller 90 stores the data.

At step 230, controller 90 asks server 110 for the date, time of day (ToD) and irrigation schedule data, and server 110 sends the data generated at steps 170 and 180 of FIG. 13 to controller 90, and controller 90 stores this data.

At step 240, the user syncs the devices in the configuration diagram with controller 90. Each device in the configuration diagram has a serial number, and a Bluetooth identification number and password, as per the Bluetooth protocol. Controller 90 sends an alert to server 110 requesting the serial numbers of the devices listed in the configuration diagram, server 110 forwards the alert to the addresses specified at step 190 of FIG. 13, and the user provides the respective device serial numbers to server 110. Server 110 uses each serial number to look up the device's Bluetooth identification number and password, and sends this information to controller 90. Controller 90 then attempts to synchronize with each device in the configuration diagram. If successful, controller 90 sends a success message to server 110 for the device. If unsuccessful, controller 90 sends a failed message to server 110 for the device, and server 110 sends an alert to the user suggesting remedial action, such as replacing the device's battery, exposing the device to sunlight to charge its photovoltaic panel, substituting another device, or omitting the device from the configuration diagram. When all devices in the configuration diagram are synced, controller 90 sends a ready-to-go alert to server 110, which forwards this alert to the addresses specified at step 190 of FIG. 13.

In some embodiments, there is also a testing phase, to confirm that controller 90 is able to control spigot V0 to provide water. The testing phase may include placing the devices of the irrigation configuration above-ground, connecting the devices according to the configuration diagram, and verifying that controller 90 can control water flow from each flow valve. The user manually ensures that each portable rake is configured so that when water is provided to its stem, the water flows out through the irrigation spikes. The testing phase may include ensuring that controller 90 can control each of the other devices in the configuration diagram: camera, lamp, motion sensor, siren.

The user then places the portable irrigation system in its operational condition, including putting the irrigation spikes of the portable rakes in the ground, connecting the water distribution pipes and artery, and mounting the other devices.

Set-up of controller 90 is now complete.

FIG. 16 is a flowchart for server software operation.

At step 900, server 110 receives a report, typically once per day, from controller 90 with any new irrigation events and any new camera images. The irrigation events and camera image are time and date stamped by controller 90 prior to being sent to server 110. At step 910, server 110 stores the irrigation events into an irrigation events log, and stores the camera images in a directory. Then, server 110 waits to receive another communication.

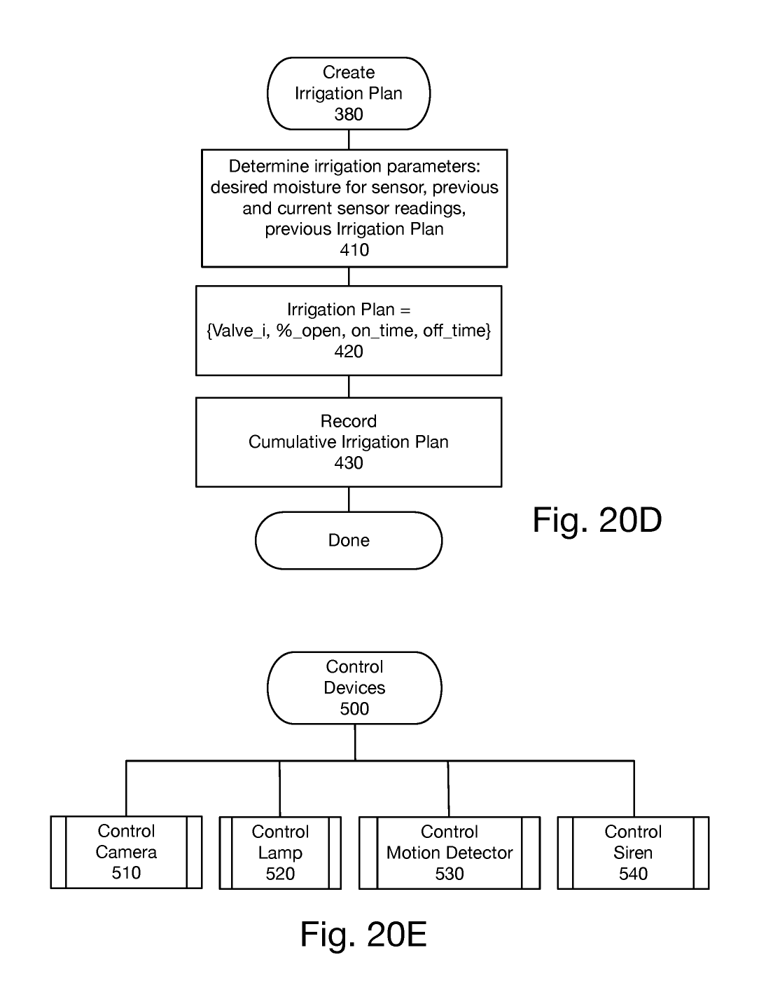

Assuming the user is communicating via smartphone 100, FIG. 17 shows a Home Screen for using server 110. The user indicates her/his choice of action by actuating a radio button next to the choice. Possible actions include viewing the irrigation events logs (see step 910), viewing a stored image (see step 910), making a time lapse video (see step 920), viewing a previously made time lapse video, viewing and/or controlling the irrigation configuration (see step 960), viewing streamed images from the camera in real time, revising the configuration diagram (see step 970), and revising set-up information (see step 980).

At step 920, server 110 receives a user command to create a time-lapse video of images captured by the camera, via the screen shown in FIG. 17. The time-lapse video will allow the user and the user's friends and family to enjoy watching the user's garden grow. Server 110 responds by providing the Time Lapse Video Screen shown in FIG. 18 to smartphone 100. In this example, there is only one camera, so there is no need to select a camera; if the configuration diagram has multiple cameras, then the user must specify which camera's images are of interest. At the top left of the Time Lapse Video Screen, there is a Go Back arrow; if actuated, this goes back to the Home Screen shown in FIG. 17.

The Time Lapse Video Screen provides fields for entering the start and end date, with default values of the earliest stored image and latest stored image from the camera.

The Time Lapse Video Screen provides a field for entering the video duration, which can be toggled between values based on the number of images in the specified date range. A time-lapse video provides 30 frames per second, with each image corresponding to a frame. In this example, the user specified an image recording schedule of 6:30 am, 9:30 am, 12:30 pm, 3:30 pm, that is, four times per day. If image recording has been occurring for three months, then there will be 3 months*30 days per month*4 images per day=360 images recorded, and the video duration can be a multiple of 360/30=12 seconds. If the user selects a 120 second (two minute) video duration, then each image is displayed for 10 frames.

The Time Lapse Video Screen provides a field for entering a title for the video, such as “Sasha's Backyard Garden 2017”, that will be a header added to each image.

The Time Lapse Video Screen provides a Create button. When actuated, server 110 creates a time lapse video according to the user's parameters, and displays the time lapse video in the image window of the Time Lapse Video Screen. Time lapse video creation software is well-known and widely available, such as Apple iMovie, Windows Moviemaker, ffmpeg (available at ffmpeg.org) and so on.

If the user is happy with the created time-lapse video, she/he can save it and send it to others by entering data in appropriate fields of the Time Lapse Video Screen. Or, the user can edit the video, via another screen (not shown), to focus on part of the image, or apply special effects such as blurring the area around the plant of interest so that only the plant of interest is displayed in detail, or adjust the color balance of images and so on.

At the conclusion of time-lapse video creation, server 110 waits to receive another communication.

At step 930, server 110 receives an alert from controller 90, such as that a moisture sensor is not working, or that motion has been detected. At step 940, server 110 sends the alert to the addresses provided at step 190 of FIG. 13. At step 950, server 110 stores the alert and confirmation that the alert was sent to an Alerts Log. Then, server 110 waits to receive another communication.

At step 960, server 110 receives a user command to provide a view/control screen, via the screen shown in FIG. 17. For instance, if the user has just gotten an alert, the user might like to see what is happening in her/his garden. Server 110 sends the View/Control Screen, shown in FIG. 19, to smartphone 100. The View/Control Screen shows the most recent image received from the camera, and provides a set of “radio buttons” so the user can take actions.

When the “camera streaming and save” radio button is actuated, the camera will stream images to controller 90, and thence to server 110 which will store the streamed images, until the radio button is de-actuated. For instance, if an animal entering the garden triggered a motion detection event, the user can capture video of the animal wandering around the garden.

When the “lamp” radio button is actuated, the lamp will turn on, and remain on until the radio button is de-actuated. Light from the lamp could help the user see things in the image, and possibly frighten the intruder.

When the “lamp blink” radio button is actuated, the lamp will turn on, and blink on and off until the radio button is de-actuated.

When the “siren” radio button is actuated, the siren will turn on, and remain on until the radio button is de-actuated. Siren noise may frighten the intruder.

Advantageously, the view/control screen allows the user to view her/his garden, and control devices, even if she/he is remote from the garden. In some embodiments, the user can configure a camera, lamp, motion detector and siren for a portion of her/his property without a garden, for use as a rudimentary security system.

At the conclusion of viewing and controlling, server 110 waits to receive another communication.

At step 970, server 110 receives a user command to revise the configuration, the command entered via the Home Screen shown in FIG. 17. For instance, the user may wish to add another row of irrigated plants. Server 110 provides a graphical user interface, described at step 150 of FIG. 13, initially populated with the stored configuration diagram. After the user drags and drops elements, or deletes elements, the new configuration diagram is saved at server 110, and processing process to step 980.

At step 980, either the user has just finished specifying a new configuration diagram, or the user has commanded server 110 to revise set-up data, the command entered via the Home Screen shown in FIG. 17. Server 110 provides a screen (not shown) populated with set-up data provided at steps 160-190 of FIG. 13, and the user can edit this data. After the user is finished editing, server 110 saves the new set-up data, and if appropriate—that is, if any of the new set-up data affects how controller 90 should operate—sends the new set-up data, and the new configuration diagram (if any) to controller 90. Then, server 110 waits to receive another communication.

At step 990, server 110 receives weather information from weather service 106. Server 110 then looks up the areas in which there are irrigation configurations where server 110 is authorized to modify irrigation schedules or plans based on weather information. Then, server 110 determines whether the weather information should result in a modification based on the rules selected at step 180 of FIG. 13. If not, server 110 waits to receive another communication.

Third-party weather information providers operate according to a “push” or “pull” model. In a push model, server 110 registers with weather service 106, such as www.weather.gov, to receive information for a particular area. In a pull model, server 110 queries weather service 106, such as www.weather.com, to obtain information for a particular area. In the case of a pull model, step 990 occurs at predetermined times of day, such as every six hours, e.g., at 4 am, 10 am, 4 pm and 10 pm daily.

When a weather-based irrigation modification needs to occur, at step 995, server 110 sends the modification for the irrigation schedule or plan to the appropriate instance of controller 90. Then, server 110 waits to receive another communication.

FIGS. 20A-20I are a flowchart for controller software operation.

As shown in FIG. 20A, controller 90 has three simultaneous processing threads, for controlling irrigation (see FIG. 20C), controlling non-irrigation devices (see FIG. 20E), and administration (see FIG. 20B).

FIG. 20B shows the processing thread for administration. There are three simultaneous processing sub-threads: daily reporting (see step 705), alert handling (see step 740), and instruction processing (see step 760).

At step 705, controller 90 checks whether it is the correct time of day for reporting, usually once per day, by looking up the reporting time of day received at step 230 of FIG. 14 and comparing the reporting time of day with the current time of day. If they are different, controller 90 keeps checking. When they are the same, at step 710, controller 90 retrieves any as yet unreported irrigation events generated at steps 320, 360 and 390 of FIG. 20C, and at step 720, controller 90 retrieves any as yet unreported images generated at step 560 of FIG. 20F. At step 730, controller 90 sends the retrieved irrigation events and images, along with date and time stamps for when they were originally stored, to server 110 (see step 900 of FIG. 16). Controller 90 then returns to step 705.

At step 740, controller 90 determines that an alert has occurred, such as detecting a bad moisture sensor (see steps 330 and 365 of FIG. 20C) or sensed motion (see step 625 of FIG. 20H). At step 750, controller 90 sends an alert event to server 110 (see step 930 of FIG. 16) along with relevant information, such as sensor identification or captured image. Controller 90 then returns to step 740.

At step 760, controller 90 receives an instruction from server 110 (see steps 960 and 980 of FIG. 16), such as to operate a non-irrigation device or to revise the stored configuration diagram or stored set-up information. At step 770, controller 90 responds to the instruction, such as by passing the instruction to its processing thread relating to the non-irrigation device (see step 565 of FIG. 20F, step 592 of FIG. 20G and step 680 of FIG. 20I)), or revising the stored configuration diagram or stored set-up information. Controller 90 then returns to step 760.

FIG. 20C shows the processing thread for controlling irrigation.

At step 305, controller 90 checks whether it is the correct time of day for irrigation by looking up the irrigation time of day data received at step 230 of FIG. 14 and comparing the irrigation time of day with the current time of day. If they are different, controller 90 keeps checking. When they are the same, at step 310, controller 90 checks whether there are any moisture sensors in the configuration diagram. If there are no sensors, then irrigation will be determined solely by the user's schedule received at step 230 of FIG. 14, and at step 315, controller 90 irrigates according to the irrigation schedule, regardless of whether it is raining. If, at step 180 of FIG. 13, the user authorized server 110 to make modifications based on weather information, and a one-time modification was sent at step 995 of FIG. 16, then at step 315, the received modification is incorporated into the irrigation schedule received at step 230 of FIG. 14. At step 320, controller 90 records that it irrigated according to the schedule. Processing returns to step 305. If the user wants to prevent irrigation during the rain, the user must remember to manually log-in to server 110, and override the irrigation schedule for a desired period such as 24 hours (not shown).

If, at step 310, controller 90 determines that there are moisture sensors in the configuration, then at step 325, controller 90 checks whether irrigation is determined dynamically, also referred to as “pure sensed” irrigation. If so, processing continues at step 365.

If irrigation is not determined dynamically, then it is hybrid irrigation, that is, according to a schedule adjusted based on readings from moisture sensors. Hybrid irrigation uses moisture sensor readings to decide whether or not to irrigate according to the schedule, whereas dynamic irrigation uses moisture sensor readings to decide how much irrigation to provide.

At step 330, controller 90 wirelessly reads the moisture sensors. If a moisture sensor is unreadable, controller 90 reports an alert to step 740 of the admin processing thread. At step 335, controller 90 compares the moisture reading for each moisture sensor with its desired moisture range received at step 230 of FIG. 14, and checks whether any moisture readings are too dry, that is, below the lowest desired moisture level. If not (all sensors readings are at least the lowest desired moisture), then there is no need to irrigate, and processing returns to step 305. Lack of need to irrigate typically occurs if it has rained recently.

However, if at least one moisture sensor reading is lower than the lowest desired moisture level, there is a need to irrigate. At step 340, controller 90 checks whether any moisture readings are too wet, that is, above the highest desired moisture level. If not, processing continues at step 350. If any sensor readings are too wet, then that area should not be irrigated, so at step 345, controller 90 performs a one-time adjustment of the irrigation schedule.

In the example above, the desired moisture ranges were specified as:

moisture sensor A: 0.5-0.7,

moisture sensor B: 0.3-0.5,

moisture sensor C: 0.2-0.3,

the association between moisture sensors and valves is:

moisture sensor A: valves VA, VA1, VA2, VA3,

moisture sensor B: valves VB, VB1, VB2, VB3,

moisture sensor A: valves VC, VC1, VC2, VC3,

and the irrigation schedule was specified as:

V0, VV=(T0) to (T0+27 minutes),

VA, VA1, VA2, VA3=(T0) to (T0+15 minutes),

VB, VB1, VB2, VB3=(T0+15 minutes) to (T0+23 minutes),

VC, VC1, VC2, VC3=(T0+23 minutes) to (T0+27 minutes).

Assume that the readings of the moisture sensors on a particular day are:

moisture sensor A: 0.45,

moisture sensor B: 0.4,

moisture sensor C: 0.35.

By comparing the readings with the ranges, it is seen that the soil at moisture sensor A (the flowering plants) is too dry, the soil at moisture sensor B (the succulents) is acceptable, and the soil at moisture sensor C (the cacti) is too wet. Because the soil at moisture sensor A is too dry, irrigation is needed. Although the soil at moisture sensor B is in the desired moisture range, it is not too wet, so it will be irrigated according to schedule. Because the soil at moisture sensor C is too wet, irrigating it would be harmful; cacti are easily killed by overwatering. So, controller 90 decides, this one time, to not irrigate the valves associated with moisture sensor C, valves VC, VC1, VC2, VC3, adjusting the irrigation schedule to be for a total of 23 minutes, not 27 minutes, as follows:

V0, VV=(T0) to (T0+23 minutes),

VA, VA1, VA2, VA3=(T0) to (T0+15 minutes),

VB, VB1, VB2, VB3=(T0+15 minutes) to (T0+23 minutes),

At step 350, controller 90 stores the moisture sensor readings and the irrigation schedule modification, if any, along with a date and time stamp, to an Irrigation Log. At step 355, controller 90 controls the valves to irrigate according to the irrigation schedule with any modifications. If, at step 180 of FIG. 13, the user authorized server 110 to make modifications based on weather information, and a one-time modification was sent at step 995 of FIG. 16, then at step 355, the received modification is incorporated into the irrigation schedule, including modifications, if any, determined by controller 90. At step 360, controller stores the event of an irrigation, along with a date and time stamp, to the Irrigation Log. Processing continues at step 305.

At step 365, controller 90 wirelessly reads the moisture sensors. If a moisture sensor is unreadable, controller 90 reports an alert to step 740 of the admin processing thread. At step 370, controller 90 stores the moisture sensor readings, along with a date and time stamp, to an Irrigation Log. At step 375, controller 90 compares the moisture reading for each moisture sensor with its desired moisture range received at step 230 of FIG. 14, and checks whether any moisture readings are too dry, that is, below the lowest desired moisture level. If not (all sensors readings are at least the lowest desired moisture), then there is no need to irrigate, and processing returns to step 305.

However, if at least one moisture sensor reading is lower than the lowest desired moisture level, there is a need to irrigate. At step 380, controller 90 creates an irrigation plan, discussed below with respect to FIG. 20D. As used herein, “irrigation schedule” is something intended to be used multiple times, whereas “irrigation plan” is intended to be used once. At step 385, controller 90 controls the valves to irrigate according to the irrigation plan. At step 390, controller stores the event of an irrigation, along with a date and time stamp, to the Irrigation Log.

Processing now returns to step 365, and the moisture sensors are read again, and at step 370, the sensor readings are stored. Controller 90 compares the most recent sensor readings with the desired moisture ranges. If all of the sensor readings are at least the desired minimum, at step 375, controller 90 determines that irrigation is complete and processing returns to step 305. However, if at least one sensor reading is too dry, steps 380, 385, 390, 365 and 370 are repeated until all of the sensor readings are at least the desired minimum.

FIG. 20D shows creation of an irrigation plan.

At step 410, controller 90 retrieves the relevant data, including most recent moisture sensor readings, desired moisture ranges, its most recent irrigation plan, and the pre- and post-irrigation moisture sensor readings associated with the most-recent irrigation plan.

If there is no most recent irrigation plan, which will occur the first time that controller 90 is used for irrigation, then controller 90 makes an initial plan comprising one minute of irrigation for each valve associated with a sensor reading that is outside the desired range, executes this plan, and obtains a new set of moisture sensor readings. If any are within the desired range, controller 90 concludes that one minute is a good irrigation duration for the valves associated with that moisture sensor. Then, controller 90 irrigates the remaining valves for one minute, and gets a new set of moisture sensor readings. If any are within the desired range, controller 90 concludes that two minutes is a good irrigation duration for the valves associated with that moisture sensor. Similarly, controller 90 continues irrigating the valves associated with the out-of-desired-range moisture sensors, for one minute intervals, until the moisture sensor readings are within the desired range. The cumulative irrigation plan is the total irrigation duration for each valve, and controller 90 records this irrigation plan. The moisture sensor readings prior to irrigation, and after irrigation, are also recorded.

At step 420, controller 90 creates an irrigation plan based on the relevant data retrieved at step 380, as follows: (i) for each moisture sensor, if the most recent sensor reading is greater than or equal to the desired midpoint, do not irrigate the valves associated with that sensor; and (ii) if the most recent sensor reading is less than the desired midpoint, irrigate the valves associated with that sensor for an amount of time calculated as:

$$\frac{\begin{matrix}( previous irrigation time ) * \\ ( midpoint of desired range - most recent reading )\end{matrix}}{\begin{matrix}( previous post \text{-} irrigation reading ) - \\ ( previous pre \text{-} irrigation reading )\end{matrix}}$$

In other embodiments, other techniques for creating an irrigation plan are used.

For example, assume that there was previous irrigation (this is not the first time controller 90 is used for irrigation), and that the relevant data are shown in Table 1.

TABLE 1

| | | Previous irrigation | Previous | Most |
|---|---|---|---|---|
| | | (pre-irrigation, | irrigation plan, | recent |
| | Desired | post-irrigation) | associated | moisture |
| | moisture | moisture sensor | valves duration | sensor |
| | ranges | readings | (minutes) | readings |
| moisture | 0.5-0.7 | (.20, .55) | 15 | 0.45 |
| sensor A | | | | |
| moisture | 0.3-0.5 | (.20, .40) | 8 | 0.40 |
| sensor B | | | | |
| moisture | 0.2-0.3 | (.20, .30) | 4 | 0.35 |
| sensor C | | | | |

Controller 90 compares the current moisture sensor readings with the current moisture sensor readings with the midpoint of the desired readings, as shown in Table 2.

TABLE 2

| | | | Difference | |
|---|---|---|---|---|
| | Current | | between | |
| | moisture | | desired | |
| | sensor | Midpoint of | midpoint and | |
| | readings | desired range | current readings | Conclusion |
| sensor | 0.45 | (.5 + .7)/2 = .60 | .6 − .45 = .15 | Irrigation |
| A | | | | needed |
| sensor | 0.40 | (.3 + .5)/2 = .40 | .4 − .4 = 0 | No irrigation |
| B | | | | |
| sensor | 0.35 | (.2 + .3)/2 = .25 | .25 − .35 = −.10 | No irrigation |
| C | | | | |

Controller 90 determines that the valves associated with moisture sensors B and C do not need irrigation, since the moisture reading is already the midpoint or greater. As compared to the hybrid approach, the dynamic approach is seen to prevent overwatering of the area associated with moisture sensor B, in this example.

Controller 90 determines the new irrigation duration for the valves associated with moisture sensor A by adjusting the previous irrigation time for the desired irrigation divided by the sensor difference caused by the previous irrigation, as shown in Table 3.

TABLE 3

| | | | Difference | |
|---|---|---|---|---|
| | Difference: | | between | |
| | previous | | desired | |
| | post- and | Previous | midpoint and | Current |
| | pre-irrigation | Irrigation | current | desired |
| | readings | minutes | readings | irrigation |
| | (Table 1) | (Table 1) | (Table 2) | minutes |
| sensor A | .55 − .20 = .35 | 15 | .15 | 15 * .15/.35 = 6.5 |

The irrigation plan in this example is:

V0, VV=(T0) to (T0+6.5 minutes),

VA, VA1, VA2, VA3=(T0) to (T0+6.5 minutes).

In embodiments wherein there is one sensor per valve, that is, one sensor per irrigation rake, it will be appreciated that the irrigation plan will be to irrigate valve by valve, so the flow control for each valve should be set to 1.0 at step 180 of FIG. 13. Here, dynamic irrigation corresponds to irrigating each portable irrigation rake, one at a time, to get the corresponding moisture sensor reading to its desired midpoint.

As compared with the hybrid irrigation, which irrigated row A for 15 minutes and row B for 8 minutes, dynamic irrigation is seen to be much more efficient in water usage—only row A is irrigated for 6.5 minutes—and accordingly better for plant comfort, assuming that the desired moisture ranges were properly specified. Both hybrid and dynamic irrigation are better than static irrigation—blindly following the irrigation schedule—which, in this example, specified irrigating row A for 15 minutes, row B for 8 minutes and row C for 4 minutes.

If, at step 180 of FIG. 13, the user authorized server 110 to make modifications based on weather information, and a one-time modification was sent at step 995 of FIG. 16, then at step 420, the received modification is incorporated into the irrigation plan determined by controller 90.

At step 430, controller 90 records the cumulative irrigation plan, which is the previous irrigation plan updated by the recent irrigation, as shown in Table 4.

TABLE 4

| | Previous | Recent | Cumulative |
|---|---|---|---|
| | irrigation | irrigation | irrigation |
| | plan | duration | plan |
| | (minutes) | (minutes) | (minutes) |
| moisture sensor A | 15 | 6.5 | 6.5 |
| moisture sensor B | 8 | 0 | 8 |
| moisture sensor C | 4 | 0 | 4 |

After the next sensor reading at step 365, at step 370, the pre- and post-sensor readings associated with the cumulative irrigation plan reflect the sensor readings only for recent irrigation. That is, after the irrigation plan of Table 3 is executed, assume that the post-irrigation sensor readings are as follows (only the reading for sensor A changed, because only the valves associated with sensor A were irrigated):

moisture sensor A: 0.61,

moisture sensor B: 0.4,

moisture sensor C: 0.35.

The pre- and post-irrigation readings associated with the cumulative irrigation plan are updated to reflect the pre- and post-irrigation readings only from moisture sensor A, as shown in Table 5.

TABLE 5

| | Previous | Recent | Cumulative |
|---|---|---|---|
| | (pre-irrigation, | (pre-irrigation, | (pre-irrigation, |
| | post-irrigation) | post-irrigation) | post-irrigation) |
| | moisture sensor | moisture sensor | moisture sensor |
| | readings | readings | readings |
| moisture sensor A | (.20, .55) | (.45, .61) | (.45, .61) |
| moisture sensor B | (.20, .40) | (.40, .40) | (.20, .40) |
| moisture sensor C | (.20, .30) | (.35, .35) | (.20, .30) |

FIG. 20E shows the processing thread for controlling non-irrigation devices. There are four simultaneous processing sub-threads: camera (see FIG. 20F), lamp (see FIG. 20G), motion detector (see FIG. 20H) and siren (see FIG. 20I).

FIG. 20F shows the processing thread for controlling a camera such as camera 84 of FIG. 12. There are two simultaneous processing sub-threads: scheduled operation (see step 550) and unscheduled operation (see step 565).

At step 550, controller 90 checks whether it is the correct time of day for capturing an image by looking up the picture time of day received at step 230 of FIG. 14 and comparing the picture time of day with the current time of day. If they are different, controller 90 keeps checking. When they are the same, at step 555, controller 90 instructs the camera to capture an image, and at step 560, controller 90 stores the image along with the date and time of storage. Controller 90 then returns to step 550.

At step 565, controller 90 receives a camera instruction (see step 770 of FIG. 20B). At step 570, controller 90 operates the camera in accordance with the instruction, such as by capturing an image, by generating a streaming video signal: capturing an image every second, or other interval, and immediately sending the image to server 110, without storing the streamed image at controller 90, or by ceasing to generate a streaming video signal. Controller 90 then returns to step 565.

FIG. 20G shows the processing thread for controlling a lamp such as lamp 83 of FIG. 12. There are two simultaneous processing sub-threads: scheduled operation (see step 580) and unscheduled operation (see step 592).

At step 580, controller 90 checks whether it is the correct time of day for turning on or off the lamp by looking up the lamp time of day received at step 230 of FIG. 14 and comparing the lamp time of day with the current time of day. If they are different, controller 90 keeps checking. When they are the same, at step 590, controller 90 instructs the lamp to turn on or off, as appropriate. Controller 90 then returns to step 580.

At step 592, controller 90 receives a lamp instruction (see step 770 of FIG. 20B). At step 594, controller 90 operates the lamp in accordance with the instruction, such as by turning on the lamp, turning off the lamp, or causing the lamp to blink: turning the lamp on and off for short intervals such as 2 seconds. Controller 90 then returns to step 592.

FIG. 20H shows the processing thread for controlling a motion detector such as motion detector 86 of FIG. 12. Typically, the motion detector is set to monitor a side of the garden, and will detect motion (trigger) when an animal-sized object, but not an insect-sized object, crosses the area being monitored. At step 605, controller 90 checks whether motion has been detected. If not, processing returns to step 605. When motion has been detected, at step 610, controller 90 instructs the camera to capture an image. At step 620, controller 90 stores the image just captured along with a notice of motion detection, and the date and time of motion detection. At step 625, controller 90 notifies its admin processing thread of a motion detection alert (see step 740 of FIG. 20B), and processing continues at step 605.

FIG. 20I shows the processing thread for controlling a siren such as siren 85 of FIG. 12. At step 680, controller 90 receives a siren instruction (see step 770 of FIG. 20B). At step 690, controller 90 operates the siren in accordance with the instruction, such as by turning on the siren or turning off the siren. Controller 90 then returns to step 680.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. A portable irrigation device comprising:
a handle for receiving the hand of a user;
a stem having a substantially cylindrical shape with a hollow interior, an elongated side, a first end and a second end, the first end connected to the handle, the stem having an opening along its elongated side for connection to a fluid source;
a base having a hollow interior, a top opening connected to the second end of the stem, and having at least one bottom opening; and
at least one irrigation spike having a hollow interior, a top end connected to the bottom opening of the base, a bottom conical tip, and at least one opening in the irrigation spike near the conical tip.

2. The irrigation device of claim 1, further comprising a spigot connected to the opening along the elongated side of the stem, the spigot having a connector for connection to a hose.

3. A kit for a portable irrigation device, comprising:
at least one handle having an end for mating with an end of a stem;
at least one stem, the stem having a hollow interior a generally cylindrical shape, the stem having two ends, one stem having an opening in its side for connection to a fluid source;
at least one base, the base having a hollow interior, a top opening for mating with an end of the at least one stem, and at least one bottom opening; and
at least one irrigation spike, the irrigation spike having a hollow interior, a top end with an opening, the top end for mating with one of the at least one bottom opening of the base, a generally cylindrical-shaped side with at least one opening, and a bottom end in the shape of a cone;
wherein assembly of the irrigation device comprises removably coupling (a) the end of the handle to one end of the stem, (b) the top opening of the base to the other end of the stem, and (c) the top end of the irrigation spike to the bottom opening of the base.

4. The kit of claim 1, further comprising a spigot having a first end for mating with the opening in the side of the stem, and a second end for mating with a hose; and wherein assembly also comprises removably coupling the first end of the spigot to the opening in the side of the stem.

5. The kit of claim 1, further comprising a fluid vat having (i) a tank with a bottom opening and (ii) means for connecting the bottom opening of the tank to the opening in the side of the stem; and wherein assembly also comprises removably coupling the connecting means of the fluid vat to the opening in the side of the stem.

6. The kit of claim 1, wherein the base has a curved shape.

7. The kit of claim 1, wherein the base has a knee-shaped segment between its top opening and its bottom opening.

8. The kit of claim 1, wherein the generally cylindrical-shaped side of the irrigation spike has a tapered cross section, with its largest cross-section being nearest its top end, and its smallest cross-section being nearest its bottom end.

9. The kit of claim 1, further comprising a faucet attachment having a first opening for connecting to a faucet, a second opening for connecting to a hose, and a third opening that is removably opened when fluid pressure inside the faucet attachment exceeds a threshold; and wherein assembly also comprises connecting the faucet attachment to the faucet, connecting the faucet attachment to a first end of the hose, and connecting a second end of the hose to the opening in the side of the stem.

10. The kit of claim 1, wherein the stem has a flow control valve that removably opens and closes to control the flow of fluid from the opening in the side of the stem to the hollow interior of the stem.

11. A kit for a portable irrigation system, comprising:
(a) at least two irrigation rakes, each irrigation rake having
at least one handle having an end for mating with an end of a stem;
at least one stem, the stem having a hollow interior a generally cylindrical shape, the stem having two ends, one stem having an opening in its side for connection to a fluid source;
at least one base, the base having a hollow interior, a top opening for mating with an end of the at least one stem, and at least one bottom opening; and
at least one irrigation spike, the irrigation spike having a hollow interior, a top end with an opening, the top end for mating with one of the at least one bottom opening of the base, a generally cylindrical-shaped side with at least one opening, and a bottom end in the shape of a cone;
(b) a pipe for connecting to the opening in the stem of each of the irrigation rakes; and
(c) a spigot for connecting to the pipe.

12. The kit of claim 11, further comprising a controller for controlling the spigot.

13. The kit of claim 12, wherein the controller has a communication interface for communicating, via a public communication network, with a server.
